(19) United States
(12) Patent Application Publication
(10) Pub. No.: US 2018/0279275 A1
(43) Pub. Date: Sep. 27, 2018

(54) METHOD AND APPARATUS OF FACILITATING REPORTING ASSISTANCE INFORMATION FOR SIDELINK SERVICE IN A WIRELESS COMMUNICATION SYSTEM

(71) Applicant: ASUSTeK COMPUTER INC., Taipei City (TW)

(72) Inventors: Wei-Yu Chen, Taipei City (TW); Li-Te Pan, Taipei City (TW)

(21) Appl. No.: 15/934,602

(22) Filed: Mar. 23, 2018

Related U.S. Application Data
(60) Provisional application No. 62/475,322, filed on Mar. 23, 2017.

(51) Int. Cl. H04W 72/04; H04W 76/27

(52) U.S. Cl. CPC H04W 72/042; H04W 76/14; H04W 76/27

(57) ABSTRACT

Facilitation reporting assistance information for sidelink service in wireless communications systems is described herein. In one example, a method for a mobile device comprises: entering, by the mobile device, a connected state; and transmitting, by the mobile device, a message to a network node after entering the connected state, wherein the message comprises a first indication for requesting a system information for sidelink and a second indication for requesting transmission resource for a sidelink service.

### CROSS-REFERENCE TO RELATED APPLICATIONS

This application claims the benefit of U.S. Provisional Application Ser. No. 62/475,322, filed Mar. 23, 2017, and titled “Method and apparatus of reporting assistance information for sidelink service in a wireless communication system,” the entirety of which is expressly incorporated herein by reference.

### TECHNICAL FIELD

The subject disclosure relates generally to communications systems, and, for example, to systems, computer-implemented methods and/or machine-readable storage media for facilitating reporting assistance information for sidelink service in wireless communications systems.

### BRIEF DESCRIPTION OF THE DRAWINGS

FIG. 1 illustrates an example, non-limiting schematic diagram of a multiple access wireless communication system that facilitates reporting assistance information for sidelink service in accordance with one or more embodiments described herein.

FIG. 2 illustrates an example, non-limiting simplified block diagram of an embodiment of a transmitter and a receiver system in a multiple input multiple output (MIMO) system in accordance with one or more embodiments described herein.

FIG. 3 illustrates an example, non-limiting block diagram of an alternative mobile device for which reporting assistance information for sidelink service can be facilitated in accordance with one or more embodiments described herein.

FIG. 4 illustrates an example, non-limiting block diagram of computer program code shown in FIG. 3 that facilitates reporting assistance information for sidelink service in accordance with one or more embodiments described herein.

FIG. 5 illustrates an example, non-limiting block diagram of a mobile device for which reporting assistance information for sidelink service can be facilitated in accordance with one or more embodiments described herein.

FIG. 6 illustrates an example, non-limiting flow diagram showing the steps for performing discovery transmission to facilitate reporting assistance information for sidelink service in accordance with one or more embodiments described herein.

FIG. 7 illustrates an example, non-limiting flow diagram showing the steps for performing discovery reception to facilitate reporting assistance information for sidelink service in accordance with one or more embodiments described herein.

FIG. 8 illustrates an example, non-limiting flow diagram showing the steps for performing sidelink communication transmission to facilitate reporting assistance information for sidelink service in accordance with one or more embodiments described herein.

FIG. 9 illustrates an example, non-limiting flow diagram showing a procedure to facilitate reporting assistance information for sidelink service in accordance with one or more embodiments described herein.

FIGS. 10, 11, 12 and 13 illustrate example, non-limiting flowcharts of computer-implemented methods facilitating reporting assistance information for sidelink service in accordance with one or more embodiments described herein.

FIG. 14 illustrates a block diagram of a computer that can be employed in accordance with one or more embodiments described herein.

FIG. 15 illustrates an overview of mobile device state machine and state transitions in NR in which a mobile device has only one RRC state in NR at one time in accordance with one or more embodiments described herein.

FIG. 16 illustrates sidelink mobile device information in accordance with one or more embodiments described herein.

### DETAILED DESCRIPTION

One or more embodiments are now described with reference to the drawings, wherein like reference numerals are used to refer to like elements throughout. In the following description, for purposes of explanation, numerous specific details are set forth to provide a thorough understanding of the various embodiments. It is evident, however, that the various embodiments can be practiced without these specific details (and without applying to any particular networked environment or standard).

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components may reside within a process and/or thread of execution and a component can be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a computer-implemented method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment (UE),” “mobile device equipment,” “mobile station,” “mobile,” subscriber station,” “mobile device,” “terminal,” “handset,” “mobile device” (and/or terms representing similar terminology) can refer to a wireless device utilized by a subscriber or mobile device of a wireless communication service to receive or convey data, control, voice, video, sound, gaming or substantially any data-stream or signaling-stream. As used herein, for example, the terms “UE” and “mobile device” can be interchangeable. The foregoing terms are utilized interchangeably herein and with reference to the related drawings. Likewise, the terms “access point (AP),” “Base Station (BS),” BS transceiver, BS device, cell site, cell site device, “Node B (NB),” “evolved Node B (eNode B),” “home Node B (HNB),” “gNB” and the like, are utilized interchangeably in the application, and refer to a wireless network component or appliance that transmits and/or receives data, control, voice, video, sound, gaming or substantially any data-stream or signaling-stream from one or more subscriber stations. Data and signaling streams can be packetized or frame-based flows.

Furthermore, the terms “device,” “mobile device,” “subscriber,” “customer entity,” “consumer,” “entity” and the like are employed interchangeably throughout, unless context warrants particular distinctions among the terms. It should be appreciated that such terms can refer to human entities or automated components supported through artificial intelligence (e.g., a capacity to make inference based on complex mathematical formalisms), which can provide simulated vision, sound recognition and so forth.

Embodiments described herein can be exploited in substantially any wireless communication technology, comprising, but not limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra mobile broadband (UMB), high speed packet access (HSPA), Z-Wave, Zigbee and other 802.XX wireless technologies and/or legacy telecommunication technologies.

One or more embodiments described herein can facilitate reporting assistance information for sidelink service in a wireless communication system. One or more embodiments can advantageously reduce delay and/or signaling overhead for requesting sidelink related system information and configuration.

Sidelink discovery/communication related AS layer behavior in LTE described in TS36.321 v14.1.0:

5.14 SL-SCH Data transfer
5.14.1 SL-SCH Data transmission
5.14.1.1 SL Grant reception and SCI transmission
In order to transmit on the SL-SCH the MAC entity must have at least one sidelink grant.
sidelink grants are selected as follows for sidelink communication:

if the MAC entity is configured to receive a single sidelink grant dynamically on the PDCCH and more data is available in STCH than can be transmitted in the current SC period, the MAC entity shall:

using the received sidelink grant determine the set of subframes in which transmission of SCI and transmission of first transport block occur according to subclause 14.2.1 of [2];

consider the received sidelink grant to be a configured sidelink grant occurring in those subframes starting at the beginning of the first available SC Period which starts at least 4 subframes after the subframe in which the sidelink grant was received, overwriting a previously configured sidelink grant occurring in the same SC period, if available;

clear the configured sidelink grant at the end of the corresponding SC Period;

else, if the MAC entity is configured by upper layers to receive multiple sidelink grants dynamically on the PDCCH and more data is available in STCH than can be transmitted in the current SC period, the MAC entity shall for each received sidelink grant:

using the received sidelink grant determine the set of subframes in which transmission of SCI and transmission of first transport block occur according to subclause 14.2.1 of [2];

consider the received sidelink grant to be a configured sidelink grant occurring in those subframes starting at the beginning of the first available SC Period which starts at least 4 subframes after the subframe in which the sidelink grant was received, overwriting a previously configured sidelink grant received in the same subframe number but in a different radio frame as this configured sidelink grant occurring in the same SC period, if available;

clear the configured sidelink grant at the end of the corresponding SC Period;

else, if the MAC entity is configured by upper layers to transmit using one or multiple pool(s) of resources as indicated in subclause 5.10.4 of [8] and more data is available in STCH than can be transmitted in the current SC period, the MAC entity shall for each sidelink grant to be selected:

if configured by upper layers to use a single pool of resources:

select that pool of resources for use;

else, if configured by upper layers to use multiple pools of resources:

select a pool of resources for use from the pools of resources configured by upper layers whose associated priority list includes the priority of the highest priority of the sidelink logical channel in the MAC PDU to be transmitted;

NOTE: If more than one pool of resources has an associated priority list which includes the priority of the sidelink logical channel with the highest priority in the MAC PDU to be transmitted, it is left for UE implementation which one of those pools of resources to select.

randomly select the time and frequency resources for SL-SCH and SCI of a sidelink grant from the selected resource pool. The random function shall be such that each of the allowed selections [2] can be chosen with equal probability;

use the selected sidelink grant to determine the set of subframes in which transmission of SCI and transmission of first transport block occur according to subclause 14.2.1 of [2];

consider the selected sidelink grant to be a configured sidelink grant occurring in those subframes starting at the beginning of the first available SC Period which starts at least 4 subframes after the subframe in which the sidelink grant was selected;

clear the configured sidelink grant at the end of the corresponding SC Period;

NOTE: Retransmissions on SL-SCH cannot occur after the configured sidelink grant has been cleared.
NOTE: If the MAC entity is configured by upper layers to transmit using one or multiple pool(s) of resources as indicated in subclause 5.10.4 of [8], it is left for UE implementation how many sidelink grants to select within one SC period taking the number of sidelink processes into account.
sidelink grants are selected as follows for V2X sidelink communication:

if the MAC entity is configured to receive a sidelink grant dynamically on the PDCCH and data is available in STCH, the MAC entity shall:

use the received sidelink grant to determine the number of HARQ retransmissions and the set of subframes in which transmission of SCI and SL-SCH occur according to subclause 14.2.1 and 14.1.1.4A of [2];

consider the received sidelink grant to be a configured sidelink grant;

else, if the MAC entity is configured by upper layers to transmit based on sensing using a pool of resources as indicated in subclause 5.10.y.1 of [8], the MAC entity selects to create a configured sidelink grant corresponding to transmissions of multiple MAC PDUs, and data is available in STCH, the MAC entity shall for each sidelink process configured for multiple transmissions based on sensing:

if SL_RESOURCE_RESELECTION_COUNTER=0 and the MAC entity randomly selects, with equal probability, a value in the interval [0, 1] which is above the probability configured by upper layers in probResourceKeep; or

if the configured sidelink grant cannot accommodate a RLC SDU by using the maximum allowed MCS configured by upper layers in maxMCS-PSSCH and the MAC entity selects not to segment the RLC SDU; or

NOTE: If the configured sidelink grant cannot accommodate the RLC SDU, it is left for UE implementation whether to perform segmentation or sidelink resource reselection.

if a pool of resources is configured or reconfigured by upper layers:

clear the configured sidelink grant, if available;

randomly select, with equal probability, an integer value in the interval [5, 15] and set SL_RESOURCE_RESELECTION_COUNTER to the selected value;

select the number of HARQ retransmissions from the allowed numbers configured by upper layers in allowedRetxNumberPSSCH, and an amount of frequency resources within the range configured by upper layers between minRB-NumberPSSCH and maxRB-NumberPSSCH;

select one of the allowed values configured by upper layers in restrictResourceReservationPeriod and set the resource reservation interval by multiplying 100 with the selected value;

NOTE: How the UE selects this integer value is up to UE implementation.

randomly select one time and frequency resource from the resources indicated by the physical layer according to subclause 14.1.1.6 of [2]. The random function shall be such that each of the allowed selections can be chosen with equal probability;

use the randomly selected resource to select a set of periodic resources spaced by the resource reservation interval for transmission opportunities of SCI and SL-SCH corresponding to the number of transmission opportunities of MAC PDUs determined in subclause 14.1.1.4B of [2];

if the number of HARQ retransmissions is equal to 1 and there are available resources left in the resources indicated by the physical layer that meet the conditions in subclause 14.1.1.7 of [2] for more transmission opportunities:

randomly select one time and frequency resource from the available resources. The random function shall be such that each of the allowed selections can be chosen with equal probability;

use the randomly selected resource to select a set of periodic resources spaced by the resource reservation interval for the other transmission opportunities of SCI and SL-SCH corresponding to the number of retransmission opportunities of the MAC PDUs determined in subclause 14.1.1.4B of [2];

consider the first set of transmission opportunities as the new transmission opportunities and the other set of transmission opportunities as the retransmission opportunities;

consider the set of new transmission opportunities and retransmission opportunities as the selected sidelink grant.

else:

consider the set as the selected sidelink grant;

use the selected sidelink grant to determine the set of subframes in which transmissions of SCI and SL-SCH occur according to subclause 14.2.1 and 14.1.1.4B of [2];

consider the selected sidelink grant to be a configured sidelink grant;

else if SL_RESOURCE_RESELECTION_COUNTER=0 and the MAC entity randomly selects, with equal probability, a value in the interval [0, 1] which is less than or equal to the probability configured by upper layers in probResourceKeep:

clear the configured sidelink grant, if available;

randomly select, with equal probability, an integer value in the interval [5, 15] and set SL_RESOURCE_RESELECTION_COUNTER to the selected value;

use the previously selected sidelink grant for the number of transmissions of the MAC PDUs determined in subclause 14.1.1.4B of [2] with the resource reservation interval to determine the set of subframes in which transmissions of SCI and SL-SCH occur according to subclause 14.2.1 and 14.1.1.4B of [2];

consider the selected sidelink grant to be a configured sidelink grant;

else, if the MAC entity is configured by upper layers to transmit based on either sensing or random selection using a pool of resources as indicated in subclause 5.10.y.1 of [8], the MAC entity selects to create a configured sidelink grant corresponding to transmission(s) of a single MAC PDU, and data is available in STCH, the MAC entity shall for a sidelink process:

select the number of HARQ retransmissions from the allowed numbers configured by upper layers in allowedRetxNumberPSSCH, and an amount of frequency resources within the range configured by upper layers between minRB-NumberPSSCH and maxRB-NumberPSSCH;

if transmission based on random selection is configured by upper layers:

randomly select the time and frequency resources for one transmission opportunity of SCI and SL-SCH from the resource pool. The random function shall be such that each of the allowed selections can be chosen with equal probability;

else:

randomly select the time and frequency resources for one transmission opportunity of SCI and SL-SCH from the resource pool indicated by the physical layer according to subclause 14.1.1.6 of [2]. The random function shall be such that each of the allowed selections can be chosen with equal probability;

if the number of HARQ retransmissions is equal to 1:

if transmission based on random selection is configured by upper layers and there are available resources that meet the conditions in subcause 14.1.1.7 of [2] for one more transmission opportunity:

randomly select the time and frequency resources for the other transmission opportunity of SCI and SL-SCH corresponding to additional transmission of the MAC PDU from the available resources. The random function shall be such that each of the allowed selections can be chosen with equal probability;

else, if transmission based on sensing is configured by upper layers and there are available resources, except the resources already excluded by the physical layer, that meet the conditions in subcause 14.1.1.7 of [2] for one more transmission opportunity:

randomly select the time and frequency resources for the other transmission opportunity of SCI and SL-SCH corresponding to additional transmission of the MAC PDU from the available resources. The random function shall be such that each of the allowed selections can be chosen with equal probability;

consider a transmission opportunity which comes first in time as the new transmission opportunity and a transmission opportunity which comes later in time as the retransmission opportunity;

consider both of the transmission opportunities as the selected sidelink grant;

else:

consider the transmission opportunity as the selected sidelink grant;

use the selected sidelink grant to determine the subframes in which transmission(s) of SCI and SL-SCH occur according to subclause 14.2.1 and 14.1.1.4B of [2];

consider the selected sidelink grant to be a configured sidelink grant;

The MAC entity shall for each subframe:

if the MAC entity has a configured sidelink grant occurring in this subframe:

if the configured sidelink grant corresponds to transmission of SCI:

instruct the physical layer to transmit SCI corresponding to the configured sidelink grant;

for V2X sidelink communication, deliver the configured sidelink grant and the associated HARQ information to the sidelink HARQ Entity for this subframe;

else if the configured sidelink grant corresponds to transmission of first transport block for sidelink communication:

deliver the configured sidelink grant and the associated HARQ information to the sidelink HARQ Entity for this subframe.

NOTE: If the MAC entity has multiple configured grants occurring in one subframe and if not all of them can be processed due to the single-cluster SC-FDM restriction, it is left for UE implementation which one of these to process according to the procedure above.
5.14.1.2 sidelink HARQ operation
5.14.1.2.1 sidelink HARQ Entity
There is one sidelink HARQ Entity at the MAC entity for transmission on SL-SCH, which maintains a number of parallel sidelink processes.
The number of transmitting sidelink processes associated with the sidelink HARQ Entity is defined in [8]. A sidelink process may be configured for multiple transmissions based on sensing. For multiple transmissions based on sensing, the maximum number of transmitting sidelink processes with the sidelink HARQ Entity is 2.
A delivered and configured sidelink grant and its associated HARQ information are associated with a sidelink process.
For each subframe of the SL-SCH and each sidelink process, the sidelink HARQ Entity shall:

if a sidelink grant corresponding to a new transmission opportunity has been indicated for this sidelink process and there is SL data, for sidelink logical channels of ProSe destination associated with this sidelink grant, available for transmission:

obtain the MAC PDU from the “Multiplexing and assembly” entity;

deliver the MAC PDU and the sidelink grant and the HARQ information to this sidelink process;

instruct this sidelink process to trigger a new transmission.

else, if this subframe corresponds to retransmission opportunity for this sidelink process:

instruct this sidelink process to trigger a retransmission.

NOTE: The resources for retransmission opportunities are specified in subclause 14.2.1 of [2] unless specified in subclause 5.14.1.1.
5.14.1.2.2 sidelink process
The sidelink process is associated with a HARQ buffer.
The sequence of redundancy versions is 0, 2, 3, 1. The variable CURRENT_IRV is an index into the sequence of redundancy versions. This variable is updated modulo 4.
New transmissions and retransmissions either for a given SC period in sidelink communication or in V2X sidelink communication are performed on the resource indicated in the sidelink grant as specified in subclause 5.14.1.1 and with the MCS configured by upper layers (if configured) unless selected below.
If the sidelink process is configured to perform multiple transmissions for V2X sidelink communication the process maintains a counter SL_RESOURCE_RESELECTION_COUNTER. For other configurations of the sidelink process, this counter is not available.
If the sidelink HARQ Entity requests a new transmission, the sidelink process shall:

for V2X sidelink communication in UE autonomous resource selection:

select a MCS which is, if configured, within the range configured by upper layers between minMCS-PSSCH and maxMCS-PSSCH;

NOTE: MCS selection is up to UE implementation if the MCS or the corresponding range is not configured by upper layers.

set CURRENT_IRV to 0;

store the MAC PDU in the associated HARQ buffer;

store the sidelink grant received from the sidelink HARQ Entity;

generate a transmission as described below.

If the sidelink HARQ Entity requests a retransmission, the sidelink process shall:

generate a transmission as described below.

To generate a transmission, the sidelink process shall:

if there is no uplink transmission or if the MAC entity is able to perform uplink transmissions and transmissions on SL-SCH simultaneously at the time of the transmission, and:

if there is no sidelink Discovery Gap for Transmission or no transmission on PSDCH at the time of the transmission:

instruct the physical layer to generate a transmission according to the stored sidelink grant with the redundancy version corresponding to the CURRENT_IRV value.

increment CURRENT_IRV by 1;

if this transmission corresponds to the last transmission of the MAC PDU:

decrement SL_RESOURCE_RESELECTION_COUNTER by 1, if available.

5.14.1.3 Multiplexing and assembly
For PDU(s) associated with one SCI, MAC shall consider only logical channels with the same Source Layer-2 ID-Destination Layer-2 ID pair.
Multiple transmissions within overlapping SC periods to different ProSe Destinations are allowed subject to single-cluster SC-FDM constraint.
In V2X sidelink communication, multiple transmissions for different sidelink processes are allowed to be independently performed in different subframes.
5.14.1.3.1 Logical channel prioritization
The Logical Channel Prioritization procedure is applied when a new transmission is performed. Each sidelink logical channel has an associated priority which is the PPPP. Multiple sidelink logical channels may have the same associated priority. The mapping between priority and LCID is left for UE implementation.
The MAC entity shall perform the following Logical Channel Prioritization procedure either for each SCI transmitted in an SC period in sidelink communication, or for each SCI corresponding to a new transmission in V2X sidelink communication:

The MAC entity shall allocate resources to the sidelink logical channels in the following steps:

Only consider sidelink logical channels not previously selected for this SC period and the SC periods (if any) which are overlapping with this SC period, to have data available for transmission in sidelink communication.

Step 0: Select a ProSe Destination, having the sidelink logical channel with the highest priority, among the sidelink logical channels having data available for transmission;

For each MAC PDU associated to the SCI:

Step 1: Among the sidelink logical channels belonging to the selected ProSe Destination and having data available for transmission, allocate resources to the sidelink logical channel with the highest priority;

Step 2: if any resources remain, sidelink logical channels belonging to the selected ProSe Destination are served in decreasing order of priority until either the data for the sidelink logical channel(s) or the SL grant is exhausted, whichever comes first. sidelink logical channels configured with equal priority should be served equally.

The UE shall also follow the rules below during the scheduling procedures above:

the UE should not segment an RLC SDU (or partially transmitted SDU) if the whole SDU (or partially transmitted SDU) fits into the remaining resources;

if the UE segments an RLC SDU from the sidelink logical channel, it shall maximize the size of the segment to fill the grant as much as possible;

the UE should maximise the transmission of data;

if the MAC entity is given an sidelink grant size that is equal to or larger than 10 bytes (for sidelink communication) or 11 bytes (for V2X sidelink communication) while having data available for transmission, the MAC entity shall not transmit only padding.

### 5.14.1.3.2 Multiplexing of MAC SDUs

The MAC entity shall multiplex MAC SDUs in a MAC PDU according to subclauses
5.14.1.3.1 and 6.1.6.

### 5.14.1.4 Buffer Status Reporting

The sidelink Buffer Status reporting procedure is used to provide the serving eNB with information about the amount of sidelink data available for transmission in the SL buffers associated with the MAC entity. RRC controls BSR reporting for the sidelink by configuring the two timers periodic-BSR-TimerSL and retx-BSR-TimerSL. Each sidelink logical channel belongs to a ProSe Destination. Each sidelink logical channel is allocated to an LCG depending on the priority of the sidelink logical channel and the mapping between LCG ID and priority which is provided by upper layers in logicalChGroupinfoList [8]. LCG is defined per ProSe Destination.
A sidelink Buffer Status Report (BSR) shall be triggered if any of the following events occur:

if the MAC entity has a configured SL-RNTI or a configured SL-V-RNTI:

SL data, for a sidelink logical channel of a ProSe Destination, becomes available for transmission in the RLC entity or in the PDCP entity (the definition of what data shall be considered as available for transmission is specified in [3] and [4] respectively and either the data belongs to a sidelink logical channel with higher priority than the priorities of the sidelink logical channels which belong to any LCG belonging to the same ProSe Destination and for which data is already available for transmission, or there is currently no data available for transmission for any of the sidelink logical channels belonging to the same ProSe Destination, in which case the sidelink BSR is referred below to as “Regular sidelink BSR”;

UL resources are allocated and number of padding bits remaining after a Padding BSR has been triggered is equal to or larger than the size of the sidelink BSR MAC control element containing the buffer status for at least one LCG of a ProSe Destination plus its subheader, in which case the sidelink BSR is referred below to as “Padding sidelink BSR”;

retx-BSR-TimerSL expires and the MAC entity has data available for transmission for any of the sidelink logical channels, in which case the sidelink BSR is referred below to as “Regular sidelink BSR”;

periodic-BSR-TimerSL expires, in which case the sidelink BSR is referred below to as “Periodic sidelink BSR”;

else:

An SL-RNTI or an SL-V-RNTI is configured by upper layers and SL data is available for transmission in the RLC entity or in the PDCP entity (the definition of what data shall be considered as available for transmission is specified in [3] and [4] respectively), in which case the sidelink BSR is referred below to as “Regular sidelink BSR”.

For Regular and Periodic sidelink BSR:

if the number of bits in the UL grant is equal to or larger than the size of a sidelink BSR containing buffer status for all LCGs having data available for transmission plus its subheader:

report sidelink BSR containing buffer status for all LCGs having data available for transmission;

else report Truncated sidelink BSR containing buffer status for as many LCGs having data available for transmission as possible, taking the number of bits in the UL grant into consideration.

For Padding sidelink BSR:

if the number of padding bits remaining after a Padding BSR has been triggered is equal to or larger than the size of a sidelink BSR containing buffer status for all LCGs having data available for transmission plus its subheader:

report sidelink BSR containing buffer status for all LCGs having data available for transmission;

else report Truncated sidelink BSR containing buffer status for as many LCGs having data available for transmission as possible, taking the number of bits in the UL grant into consideration.

If the Buffer Status reporting procedure determines that at least one sidelink BSR has been triggered and not cancelled:

if the MAC entity has UL resources allocated for new transmission for this TTI and the allocated UL resources can accommodate a sidelink BSR MAC control element plus its subheader as a result of logical channel prioritization:

instruct the Multiplexing and Assembly procedure to generate the sidelink BSR MAC control element(s);

start or restart periodic-BSR-TimerSL except when all the generated sidelink BSRs are Truncated sidelink BSRs;

start or restart retx-BSR-TimerSL;

else if a Regular sidelink BSR has been triggered:

if an uplink grant is not configured:

a Scheduling Request shall be triggered.

A MAC PDU shall contain at most one sidelink BSR MAC control element, even when multiple events trigger a sidelink BSR by the time a sidelink BSR can be transmitted in which case the Regular sidelink BSR and the Periodic sidelink BSR shall have precedence over the padding sidelink BSR.
The MAC entity shall restart retx-BSR-TimerSL upon reception of an SL grant.
All triggered regular sidelink BSRs shall be cancelled in case the remaining configured SL grant(s) valid for this SC Period can accommodate all pending data available for transmission in sidelink communication or in case the remaining configured SL grant(s) valid can accommodate all pending data available for transmission in V2X sidelink communication. All triggered sidelink BSRs shall be cancelled in case the MAC entity has no data available for transmission for any of the sidelink logical channels. All triggered sidelink BSRs shall be cancelled when a sidelink BSR (except for Truncated sidelink BSR) is included in a MAC PDU for transmission. All triggered sidelink BSRs shall be cancelled, and retx-BSR-TimerSL and periodic-BSR-TimerSL shall be stopped, when upper layers configure autonomous resource selection.
The MAC entity shall transmit at most one Regular/Periodic sidelink BSR in a TTI. If the MAC entity is requested to transmit multiple MAC PDUs in a TTI, it may include a padding sidelink BSR in any of the MAC PDUs which do not contain a Regular/Periodic sidelink BSR.
All sidelink BSRs transmitted in a TTI always reflect the buffer status after all MAC PDUs have been built for this TTI. Each LCG shall report at the most one buffer status value per TTI and this value shall be reported in all sidelink BSRs reporting buffer status for this LCG.
NOTE: A Padding sidelink BSR is not allowed to cancel a triggered Regular/Periodic sidelink BSR. A Padding sidelink BSR is triggered for a specific MAC PDU only and the trigger is cancelled when this MAC PDU has been built.
5.14.2 SL-SCH Data reception
5.14.2.1 SCI reception
SCI transmitted on the PSCCH indicate if there is a transmission on SL-SCH and provide the relevant HARQ information.
The MAC entity shall:

for each subframe during which the MAC entity monitors PSCCH:

if SCI for this subframe has been received on the PSCCH for sidelink communication with a Group Destination ID of interest to this MAC entity:

determine the set of subframes in which reception of the first transport blocks occur according to subclause 14.2.2 of [2] using the received SCI;

store the SCI and associated HARQ information as SCI valid for the subframes corresponding to first transmission of each transport block;

else if SCI for this subframe has been received on the PSCCH for V2X sidelink communication:

determine the set of subframes in which reception of the transport block occur according to subclause 14.1.2 of [2] using the received SCI;

store the SCI and associated HARQ information as SCI valid for the subframes corresponding to transmission(s) of the transport block;

for each subframe for which the MAC entity has a valid SCI:

deliver the SCI and the associated HARQ information to the sidelink HARQ Entity.

5.14.2.2 Sidelink HARQ operation

### 5.14.2.2.1 Sidelink HARQ Entity

There is one sidelink HARQ Entity at the MAC entity for reception of the SL-SCH which maintains a number of parallel sidelink processes.
Each sidelink process is associated with SCI in which the MAC entity is interested. If SCI includes the Group Destination ID, this interest is as determined by the Group Destination ID of the SCI. The sidelink HARQ Entity directs HARQ information and associated TBs received on the SL-SCH to the corresponding sidelink processes.
The number of Receiving sidelink processes associated with the sidelink HARQ Entity is defined in [8].
For each subframe of the SL-SCH, the sidelink HARQ Entity shall:
for each SCI valid in this subframe:
allocate the TB received from the physical layer and the associated HARQ information to a sidelink process, associate this sidelink process with this SCI and consider this transmission to be a new transmission.
for each sidelink process:
if this subframe corresponds to retransmission opportunity for the sidelink process according to its associated SCI:
allocate the TB received from the physical layer and the associated HARQ information to the sidelink process and consider this transmission to be a retransmission.
   5.14.2.2.2 sidelink process
   For each subframe where a transmission takes place for the sidelink process, one TB and the associated HARQ information is received from the sidelink HARQ Entity.
   The sequence of redundancy versions is 0, 2, 3, 1. The variable CURRENT_IRV is an index into the sequence of redundancy versions. This variable is updated modulo 4.
   For each received TB and associated HARQ information, the sidelink process shall:

if this is a new transmission:

set CURRENT_IRV to 0;

store the received data in the soft buffer and optionally attempt to decode the received data according to CURRENT_IRV.

else if this is a retransmission:

if the data for this TB has not yet been successfully decoded:

increment CURRENT_IRV by 1;

combine the received data with the data currently in the soft buffer for this TB and optionally attempt to decode the combined data according to the CURRENT_IRV.

if the data which the MAC entity attempted to decode was successfully decoded for this TB:

if this is the first successful decoding of the data for this TB:

if the DST field of the decoded MAC PDU subheader is equal to the 16 MSB of any of the Destination Layer-2 ID(s) of the UE for which the 8 LSB are equal to the Group Destination ID in the corresponding SCI:

deliver the decoded MAC PDU to the disassembly and demultiplexing entity.

else if the DST field of the decoded MAC PDU subheader is equal to any of the Destination Layer-2 ID(s) of the UE:

deliver the decoded MAC PDU to the disassembly and demultiplexing entity.

5.14.2.3 Disassembly and demultiplexing
The MAC entity shall disassemble and demultiplex a MAC PDU as defined in subclause
6.1.6.
5.15 SL-DCH data transfer
5.15.1 SL-DCH data transmission
5.15.1.1 Resource allocation
In order to transmit MAC PDU(s) on SL-DCH, the MAC entity shall for every discovery period and each MAC PDU:

if the MAC entity is configured by upper layers with a specific grant as specified in [8]:

using the specific grant determine the set of subframes in which a transmission of new MAC PDU(s) occur according to subclause 14.3.1 of [2];

consider the determined set of subframes to be a configured grant for the corresponding discovery period;

for every subframe, if the MAC entity has a configured grant occurring in that subframe, deliver the configured grant and the MAC PDU to the sidelink HARQ Entity;

clear the configured grant at the end of the corresponding discovery period.

NOTE: Mapping between grant and physical resources is specified in subclause 9.5.6 of [7].

else if the MAC entity is configured with a single pool of resources by upper layers:

select a random value p1 in the range from 0 to 1, where the random function shall be such that each of the allowed selections can be chosen with equal probability;

if p1 is less than txProbability:

select a random resource from the pool of resources (excluding any resources which are overlapping with PRACH or resources belonging to the subframes of resources already selected for transmissions on SL-DCH in this discovery period), where the random function shall be such that each of the allowed selections (see subclause 14.3.1 of [2]) can be chosen with equal probability;

using the selected resource determine the set of subframes in which the transmission of a MAC PDU can occur according to subclause 14.3.1 of [2]

consider the determined set of subframes to be a configured grant for the corresponding discovery period;

for every subframe, if the MAC entity has a configured grant occurring in that subframe, deliver the configured grant and the MAC PDU to the sidelink HARQ Entity;

clear the configured grant at the end of the corresponding discovery period.

5.15.1.2 Sidelink HARQ operation

### 5.15.1.2.1 Sidelink HARQ Entity

There is one sidelink HARQ Entity at the MAC entity for transmission on SL-DCH, which maintains one sidelink process for each MAC PDU.
For each subframe of the SL-DCH the sidelink HARQ Entity shall:

if a grant and a MAC PDU has been delivered for this subframe to the sidelink HARQ Entity:

deliver the MAC PDU and the grant to the sidelink process;

instruct the sidelink process to trigger a new transmission.

else, if this subframe corresponds to retransmission opportunity for the sidelink process:

instruct the sidelink process to trigger a retransmission.

5.15.1.2.2 sidelink process
The sidelink process is associated with a HARQ buffer.
The sidelink process shall maintain a state variable CURRENT_TX_NB, which indicates the number of transmissions that have taken place for the MAC PDU currently in the buffer. When the sidelink process is established, CURRENT_TX_NB shall be initialized to 0.
The sequence of redundancy versions is 0, 2, 3, 1. The variable CURRENT_IRV is an index into the sequence of redundancy versions. This variable is up-dated modulo 4.
The sidelink process is configured with a maximum number of HARQ retransmissions by RRC: numRetx.
If the sidelink HARQ Entity requests a new transmission, the sidelink process shall:

set CURRENT_TX_NB to 0;

set CURRENT_IRV to 0;

store the MAC PDU in the associated HARQ buffer;

store the grant received from the sidelink HARQ Entity;

generate a transmission as described below.

If the sidelink HARQ Entity requests a retransmission, the sidelink process shall:

increment CURRENT_TX_NB by 1;

generate a transmission as described below.

To generate a transmission, the sidelink process shall:

if there is no uplink transmission, no transmission or reception on PSCCH, and no transmission or reception on PSSCH at the time of the transmission; or

if there is a sidelink Discovery Gap for Transmission at the time of transmission:

instruct the physical layer to generate a transmission according to the grant with the redundancy version corresponding to the CURRENT_IRV value.

increment CURRENT_IRV by 1.

After performing above actions, the sidelink process then shall:

if CURRENT_TX_NB=numRetx:

flush the HARQ buffer.

5.15.2 SL-DCH data reception
5.15.2.1 sidelink HARQ operation
5.15.2.1.1 sidelink HARQ Entity
There is one sidelink HARQ Entity at the MAC entity for reception on the SL-DCH which maintains a number of parallel sidelink processes. The sidelink HARQ Entity directs HARQ information and associated TBs received on the SL-DCH to the corresponding sidelink processes.
The number of receiving sidelink processes per sidelink HARQ Entity is specified in [8].
For each subframe of the SL-DCH, the sidelink HARQ Entity shall:

receive the TB and the associated HARQ information from the physical layer;

if this subframe corresponds to a new transmission opportunity:

allocate the received TB (if any) and the associated HARQ information to a non-running sidelink process and consider this transmission to be a new transmission.

else, if this subframe corresponds to a retransmission opportunity:

allocate the received TB (if any) and the associated HARQ information to its sidelink process and consider this transmission to be a retransmission.

5.15.2.1.2 sidelink process
For each subframe where a transmission takes place for the sidelink process, one TB and the associated HARQ information is received from the sidelink HARQ Entity.
The sequence of redundancy versions is 0, 2, 3, 1. The variable CURRENT_IRV is an index into the sequence of redundancy versions. This variable is updated modulo 4.
The sidelink process shall:

if this subframe corresponds to a new transmission opportunity:

set CURRENT_IRV to 0;

else, if this subframe corresponds to a retransmission opportunity:

increment CURRENT_IRV by 1.

if a TB was allocated to the sidelink process:

if this is a new transmission:

optionally store the received data in the soft buffer and attempt to decode the received data according to the CURRENT_IRV.

else if this is a retransmission:

if the data for this TB has not yet been successfully decoded:

optionally combine the received data with the data currently in the soft buffer for this TB and attempt to decode the combined data according to the CURRENT_IRV.

if the data which the MAC entity attempted to decode was successfully decoded for this TB:

if this is the first successful decoding of the data for this TB:

deliver the decoded MAC PDU to upper layers.

New state called RRC_INACTIVE state is introduced in 3GPP TR 38.804:

### 5.5 RRC

This sub-clause provides an overview on services and functions provided by the RRC sublayer.

### 5.5.1 Functions

The main services and functions of the RRC sublayer include:

Broadcast of System Information related to AS and NAS;

Paging initiated by CN or RAN;

Establishment, maintenance and release of an RRC connection between the UE and NR RAN including:

Addition, modification and release of carrier aggregation;

Addition, modification and release of Dual Connectivity in NR or between LTE and NR [FFS: or between NR and WLAN];

Security functions including key management;

Establishment, configuration, maintenance and release of signalling radio bearers and data radio bearers;

Mobility functions including:

Handover;

UE cell selection and reselection and control of cell selection and reselection;

Context transfer at handover.

QoS management functions;

UE measurement reporting and control of the reporting;

NAS message transfer to/from NAS from/to UE.

5.5.2 UE states and state transitions
RRC supports the following three states which can be characterised as follows:

RRC_IDLE:

Cell re-selection mobility;

[FFS: The UE AS context is not stored in any gNB or in the UE;]

Paging is initiated by CN;

Paging area is managed by CN.

RRC_INACTIVE:

Cell re-selection mobility;

CN—NR RAN connection (both C/U-planes) has been established for UE;

The UE AS context is stored in at least one gNB and the UE;

Paging is initiated by NR RAN;

RAN-based notification area is managed by NR RAN;

NR RAN knows the RAN-based notification area which the UE belongs to;

RRC_CONNECTED:

The UE has an NR RRC connection;

The UE has an AS context in NR;

NR RAN knows the cell which the UE belongs to;

Transfer of unicast data to/from the UE;

Network controlled mobility, i.e. handover within NR and to/from E-UTRAN.

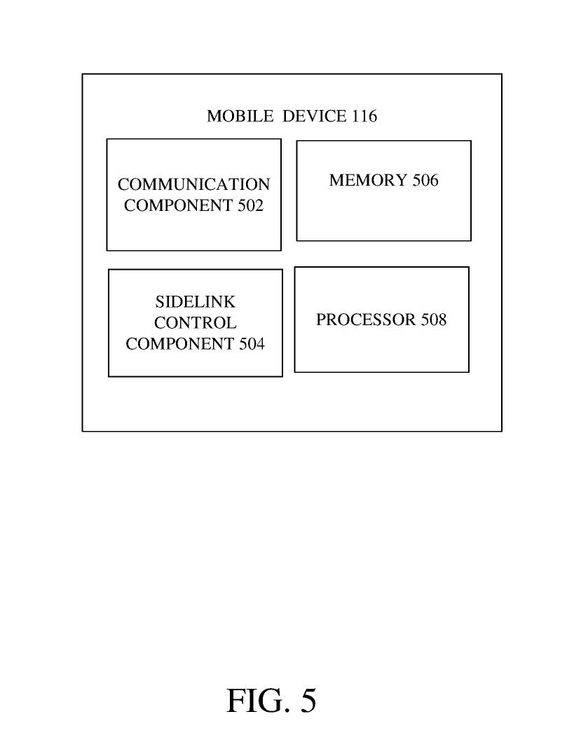

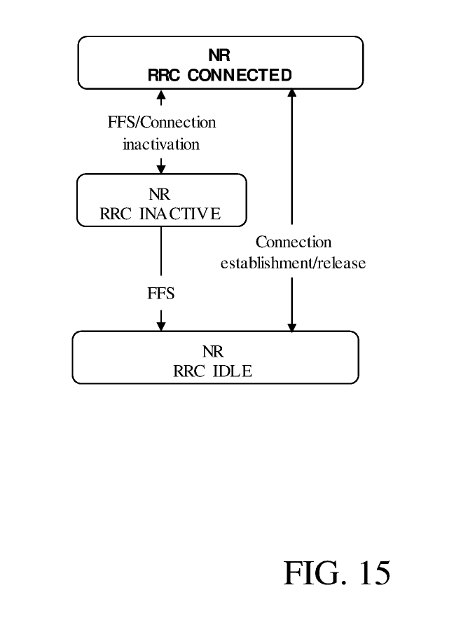

NOTE 1: How to model RRC_INACTIVE in the specification will be decided in the work item phase.
FIG. 15 is a reproduction of FIG. 5.5.2-1 from 3GPP TR 38.804 illustrates an overview of UE state machine and state transitions in NR. A UE has only one RRC state in NR at one time.
NOTE 2: It is FFS how the UE transits from RRC_INACTIVE to RRC_IDLE in NR. NOTE 3: It is FFS how the UE transits from RRC_CONNECTED to RRC_INACTIVE
Paging operation details for the NR RRC_IDLE and RRC_INACTIVE state are specified in 10.1.1.2.
The following state transitions are supported between the aforementioned RRC states (as also presented in FIG. 5.5.2-1):

from RRC_IDLE to RRC_CONNECTED, following the “connection setup” procedure (e.g., request, setup, complete);

from RRC_CONNECTED to RRC_IDLE, following (at least) the “connection release” procedure;

from RRC_CONNECTED to RRC_INACTIVE, following the “connection inactivation” procedure;

from RRC_INACTIVE to RRC_CONNECTED, following the “connection activation” procedure;

from RRC_INACTIVE to RRC_IDLE.

NOTE 4: Number of steps for each RRC procedure and the corresponding RRC message will be decided in the work item phase.

Sidelink discovery/communication related procedures in LTE were introduced in 3GPP TS 36.331 v14.1.0:

5.10 sidelink

### 5.10.1 Introduction

The sidelink communication and associated synchronisation resource configuration applies for the frequency at which it was received/acquired. Moreover, for a UE configured with one or more SCells, the sidelink communication and associated synchronisation resource configuration provided by dedicated signalling applies for the PCell/the primary frequency. The sidelink discovery and associated synchronisation resource configuration applies for the frequency at which it was received/acquired or the indicated frequency in the configuration. For a UE configured with one or more SCells, the sidelink discovery and associated synchronisation resource configuration provided by dedicated signalling applies for the the PCell/the primary frequency/any other indicated frequency.
NOTE 1: Upper layers configure the UE to receive or transmit sidelink communication on a specific frequency, to monitor or transmit non-PS related sidelink discovery announcements on one or more frequencies or to monitor or transmit PS related sidelink discovery announcements on a specific frequency, but only if the UE is authorised to perform these particular ProSe related sidelink activities.
NOTE 2: It is up to UE implementation which actions to take (e.g., termination of unicast services, detach) when it is unable to perform the desired sidelink activities, e.g., due to UE capability limitations.
sidelink communication consists of one-to-many and one-to-one sidelink communication. One-to-many sidelink communication consists of relay related and non-relay related one-to-many sidelink communication. One-to-one sidelink communication consists of relay related and non-relay related one-to-one sidelink communication. In relay related one-to-one sidelink communication the communicating parties consist of one sidelink relay UE and one sidelink remote UE.
sidelink discovery consists of public safety related (PS related) and non-PS related sidelink discovery. PS related sidelink discovery consists of relay related and non-relay related PS related sidelink discovery. Upper layers indicate to RRC whether a particular sidelink announcement is PS related or non-PS related.
Upper layers indicate to RRC whether a particular sidelink procedure is V2X related or not.
The specification covers the use of UE to network sidelink relays by specifying the additional requirements that apply for a sidelink relay UE and a sidelink remote UE. I.e. for such UEs the regular sidelink UE requirements equally apply unless explicitly stated otherwise.
5.10.1a Conditions for sidelink communication operation
When it is specified that the UE shall perform sidelink communication operation only if the conditions defined in this section are met, the UE shall perform sidelink communication operation only if:
1> if the UE's serving cell is suitable (RRC_IDLE or RRC_CONNECTED); and if either the selected cell on the frequency used for sidelink communication operation belongs to the registered or equivalent PLMN as specified in TS 24.334 [69] or the UE is out of coverage on the frequency used for sidelink communication operation as defined in TS 36.304 [4, 11.4]; or
1> if the UE is camped on a serving cell (RRC_IDLE) on which it fulfils the conditions to support sidelink communication in limited service state as specified in TS 23.303 [68, 4.5.6]; and if either the serving cell is on the frequency used for sidelink communication operation or the UE is out of coverage on the frequency used for sidelink communication operation as defined in TS 36.304 [4, 11.4]; or
1> if the UE has no serving cell (RRC_IDLE);
5.10.1b Conditions for PS related sidelink discovery operation
When it is specified that the UE shall perform PS related sidelink discovery operation only if the conditions defined in this section are met, the UE shall perform PS related sidelink discovery operation only if:
1> if the UE's serving cell is suitable (RRC_IDLE or RRC_CONNECTED); and if either the selected cell on the frequency used for PS related sidelink discovery operation belongs to the registered or other PLMN as specified in TS 24.334 [69] or the UE is out of coverage on the frequency used for PS related sidelink discovery operation as defined in TS 36.304 [4, 11.4]; or
1> if the UE is camped on a serving cell (RRC_IDLE) on which it fulfils the conditions to support sidelink discovery in limited service state as specified in TS 23.303 [68, 4.5.6]; and if either the serving cell is on the frequency used for PS related sidelink discovery operation or the UE is out of coverage on the frequency used for PS related sidelink discovery operation as defined in TS 36.304 [4, 11.4]; or
1> if the UE has no serving cell (RRC_IDLE);
5.10.1c Conditions for non-PS related sidelink discovery operation
When it is specified that the UE shall perform non-PS related sidelink discovery operation only if the conditions defined in this section are met, the UE shall perform non-PS related sidelink discovery operation only if:
1> if the UE's serving cell (RRC_IDLE) or PCell (RRC_CONNECTED) is suitable; and if the selected cell on the frequency used for non-PS related sidelink discovery operation belongs to the registered or other PLMN as specified in TS 24.334 [69].
5.10.1d Conditions for V2X sidelink communication operation
When it is specified that the UE shall perform V2X sidelink communication operation only if the conditions defined in this section are met, the UE shall perform V2X sidelink communication operation only if:
1> if the UE's serving cell is suitable (RRC_IDLE or RRC_CONNECTED); and if either the selected cell on the frequency used for V2X sidelink communication operation belongs to the registered or equivalent PLMN as specified in TS 24.334 [69] or the UE is out of coverage on the frequency used for V2X sidelink communication operation as defined in TS 36.304 [4, 11.4]; or
1> if the UE has no serving cell (RRC_IDLE);
5.10.2 sidelink UE information

### 5.10.2.1 General

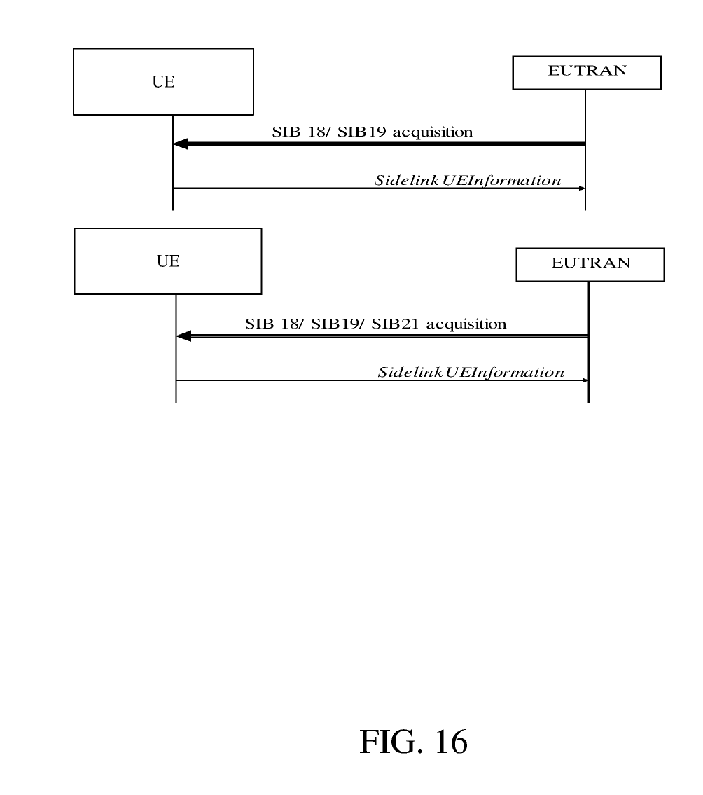

FIG. 16 shows sidelink UE information is a reproduction of FIG. 5.10.2.1 from 3GPP TS 36.331 v14.1.0 “Evolved Universal Terrestrial Radio Access (E-UTRA); Radio Resource Control (RRC); Protocol specification”.
The purpose of this procedure is to inform E-UTRAN that the UE is interested or no longer interested to receive sidelink communication or discovery, to receive V2X sidelink communication, as well as to request assignment or release of transmission resources for sidelink communication or discovery announcements or V2X sidelink communication or sidelink discovery gaps and to report parameters related to sidelink discovery from system information of inter-frequency/PLMN cells.

### 5.10.2.2 Initiation

A UE capable of sidelink communication or V2X sidelink communication or sidelink discovery that is in RRC_CONNECTED may initiate the procedure to indicate it is (interested in) receiving sidelink communication or V2X sidelink communication or sidelink discovery in several cases including upon successful connection establishment, upon change of interest, upon change to a PCell broadcasting SystemInformationBlockType18 or SystemInformationBlockType19 or SystemInformationBlockType21 including sl-V2X-ConfigCommon. A UE capable of sidelink communication or V2X sidelink communication or sidelink discovery may initiate the procedure to request assignment of dedicated resources for the concerned sidelink communication transmission or discovery announcements or V2X sidelink communication transmission or to request sidelink discovery gaps for sidelink discovery transmission or sidelink discovery reception and a UE capable of inter-frequency/PLMN sidelink discovery parameter reporting may initiate the procedure to report parameters related to sidelink discovery from system information of inter-frequency/PLMN cells.
NOTE 1: A UE in RRC_IDLE that is configured to transmit sidelink communication/V2X sidelink communication/sidelink discovery announcements, while SystemInformationBlockType18/SystemInformationBlockType19/SystemInformationBlockType21 including sl-V2X-ConfigCommon does not include the resources for transmission (in normal conditions), initiates connection establishment in accordance with 5.3.3.1a.
Upon initiating the procedure, the UE shall:
1> if SystemInformationBlockType18 is broadcast by the PCell:
2> ensure having a valid version of SystemInformationBlockType18 for the PCell;
2> if configured by upper layers to receive sidelink communication:
3> if the UE did not transmit a sidelinkUEInformation message since last entering RRC_CONNECTED state; or
3> if since the last time the UE transmitted a sidelinkUEInformation message the UE connected to a PCell not broadcasting SystemInformationBlockType18; or
NOTE 2: After handover/re-establishment from a source PCell not broadcasting SystemInformationBlockType18 the UE repeats the same interest information that it provided previously as such a source PCell may not forward the interest information.
3> if the last transmission of the sidelinkUEInformation message did not include commRxInterestedFreq; or if the frequency configured by upper layers to receive sidelink communication on has changed since the last transmission of the sidelinkUEInformation message:
4> initiate transmission of the sidelinkUEInformation message to indicate the sidelink communication reception frequency of interest in accordance with 5.10.2.3;
2> else:
3> if the last transmission of the Information message included commRxInterestedFreq:
4> initiate transmission of the sidelinkUEInformation message to indicate it is no longer interested in sidelink communication reception in accordance with 5.10.2.3;
2> if configured by upper layers to transmit non-relay related one-to-many sidelink communication:
3> if the UE did not transmit a sidelinkUEInformation message since last entering RRC_CONNECTED state; or
3> if since the last time the UE transmitted a sidelinkUEInformation message the UE connected to a PCell not broadcasting SystemInformationBlockType18; or
3> if the last transmission of the sidelinkUEInformation message did not include commTxResourceReq; or if the information carried by the commTxResourceReq has changed since the last transmission of the sidelinkUEInformation message:
4> initiate transmission of the sidelinkUEInformation message to indicate the non-relay related one-to-many sidelink communication transmission resources required by the UE in accordance with 5.10.2.3;
2> else:
3> if the last transmission of the sidelinkUEInformation message included commTxResourceReq:
4> initiate transmission of the sidelinkUEInformation message to indicate it no longer requires non-relay related one-to-many sidelink communication transmission resources in accordance with 5.10.2.3;
2> if configured by upper layer to transmit relay related one-to-many sidelink communication:
3> if the UE did not transmit a sidelinkUEInformation message since entering RRC_CONNECTED state; or
3> if since the last time the UE transmitted a sidelinkUEInformation message the UE connected to a PCell not broadcasting SystemInformationBlockType18, connected to a PCell not broadcasting SystemInformationBlockType19 or broadcasting SystemInformationBlockType19 not including discConfigRelay; or
3> if the last transmission of sidelinkUEInformation message did not include commTxResourceReqRelay; or if the information carried by the commTxResourceReqRelay has changed since the last transmission of the sidelinkUEInformation message:
4> if the UE is acting as sidelink relay UE:
5> initiate transmission of the sidelinkUEInformation message to indicate the relay related one-to-many sidelink communication transmission resources required by the UE in accordance with 5.10.2.3;
2> else:
3> if the last transmission of the sidelinkUEInformation message included commTxResourceReqRelay:
4> initiate transmission of the sidelinkUEInformation message to indicate it no longer requires relay related one-to-many sidelink communication transmission resources in accordance with 5.10.2.3;
2> if configured by upper layers to transmit non-relay related one-to-one sidelink communication:
3> if the UE did not transmit a sidelinkUEInformation message since last entering RRC_CONNECTED state; or
3> if since the last time the UE transmitted a sidelinkUEInformation message the UE connected to a PCell not broadcasting SystemInformationBlockType18 or connected to a PCell broadcasting SystemInformationBlockType18 not including commTxResourceUC-ReqAllowed; or
3> if the last transmission of the sidelinkUEInformation message did not include commTxResourceReqUC; or if the information carried by the commTxResourceReqUC has changed since the last transmission of the sidelinkUEInformation message:
4> if commTxResourceUC-ReqAllowed is included in SystemInformationBlockType18:
5> initiate transmission of the sidelinkUEInformation message to indicate the non-relay related one-to-one sidelink communication transmission resources required by the UE in accordance with 5.10.2.3;
2> else:
3> if the last transmission of the sidelinkUEInformation message included commTxResourceReqUC:
4> initiate transmission of the sidelinkUEInformation message to indicate it no longer requires non-relay related one-to-one sidelink communication transmission resources in accordance with 5.10.2.3;
2> if configured by upper layers to transmit relay related one-to-one sidelink communication:
3> if the UE did not transmit a sidelinkUEInformation message since last entering RRC_CONNECTED state; or
3> if since the last time the UE transmitted a sidelinkUEInformation message the UE connected to a PCell not broadcasting SystemInformationBlockType18, connected to a PCell not broadcasting SystemInformationBlockType19 or broadcasting SystemInformationBlockType19 not including discConfigRelay; or
3> if the last transmission of the sidelinkUEInformation message did not include commTxResourceReqRelayUC; or if the information carried by the commTxResourceReqRelayUC has changed since the last transmission of the sidelinkUEInformation message:
4> if the UE is acting as sidelink relay UE; or:
4> if the UE has a selected sidelink relay UE; and if SystemInformationBlockType19 is broadcast by the PCell and includes discConfigRelay; and if the sidelink remote UE threshold conditions as specified in 5.10.11.5 are met;
5> initiate transmission of the sidelinkUEInformation message to indicate the relay related one-to-one sidelink communication transmission resources required by the UE in accordance with 5.10.2.3;
2> else:
3> if the last transmission of the sidelinkUEInformation message included commTxResourceReqRelayUC:
4> initiate transmission of the sidelinkUEInformation message to indicate it no longer requires relay related one-to-one sidelink communication transmission resources in accordance with 5.10.2.3;
1> if SystemInformationBlockType19 is broadcast by the PCell:
2> ensure having a valid version of SystemInformationBlockType19 for the PCell;
2> if configured by upper layers to receive sidelink discovery announcements on a serving frequency or on one or more frequencies included in discInterFreqList, if included in SystemInformationBlockType19 of the PCell:
3> if the UE did not transmit a sidelinkUEInformation message since last entering RRC_CONNECTED state; or
3> if since the last time the UE transmitted a sidelinkUEInformation message the UE connected to a PCell not broadcasting SystemInformationBlockType19; or
3> if the last transmission of the sidelinkUEInformation message did not include discRxInterest:
4> initiate transmission of the sidelinkUEInformation message to indicate it is interested in sidelink discovery reception in accordance with 5.10.2.3;
2> else:
3> if the last transmission of the sidelinkUEInformation message included discRxInterest:
4> initiate transmission of the sidelinkUEInformation message to indicate it is no longer interested in sidelink discovery reception in accordance with 5.10.2.3;
2> if the UE is configured by upper layers to transmit non-PS related sidelink discovery announcements on the primary frequency or on one or more frequencies included in discInterFreqList, if included in SystemInformationBlockType19 of the PCell, with discTxResourcesInterFreq included within discResourcesNonPS and not set to noTxOnCarrier:
3> if the UE did not transmit a sidelinkUEInformation message since last entering RRC_CONNECTED state; or
3> if since the last time the UE transmitted a sidelinkUEInformation message the UE connected to a PCell not broadcasting SystemInformationBlockType19 or connected to a PCell broadcasting SystemInformationBlockType19 not including discTxResourcesInterFreq within discResourcesNonPS or discTxResourcesInterFreq did not include all frequencies for which the UE will request resources; or
3> if the last transmission of the sidelinkUEInformation message did not include discTxResourceReq; or if the non-PS related sidelink discovery announcement resources required by the UE have changed (i.e. resulting in a change of discTxResourceReq) since the last transmission of the sidelinkUEInformation message:
4> initiate transmission of the sidelinkUEInformation message to indicate the non-PS related sidelink discovery announcement resources required by the UE in accordance with 5.10.2.3;
2> else:
3> if the last transmission of the sidelinkUEInformation message included discTxResourceReq:
4> initiate transmission of the sidelinkUEInformation message to indicate it no longer requires non-PS related sidelink discovery announcement resources in accordance with 5.10.2.3;
2> if configured by upper layers to transmit PS related sidelink discovery announcements on the primary frequency or, in case of non-relay PS related sidelink discovery announcements, on a frequency included in discInterFreqList, if included in SystemInformationBlockType19, with discTxResourcesInterFreq included within discResourcesPS and not set to noTxOnCarrier:
3> if the UE did not transmit a sidelinkUEInformation message since last entering RRC_CONNECTED state; or
3> if since the last time the UE transmitted a sidelinkUEInformation message the UE connected to a PCell not broadcasting SystemInformationBlockType19, connected to a PCell broadcasting SystemInformationBlockType19 not including discConfigPS, or in case of non-relay PS related transmission: (connected to a PCell broadcasting SystemInformationBlockType19 not including discTxResourcesInterFreq within discResourcesPS or for which discTxResourcesInterFreq did not include all frequencies for which the UE will request resources), or in case of relay related PS sidelink discovery announcements: (connected to a PCell broadcasting SystemInformationBlockType19 not including discConfigRelay) sidelink; or
3> if the last transmission of the sidelinkUEInformation message did not include discTxResourceReqPS; or if the PS related sidelink discovery announcement resources required by the UE have changed (i.e. resulting in a change of discTxResourceReqPS) since the last transmission of the sidelinkUEInformation message:
4> if configured by upper layers to transmit non-relay PS related sidelink discovery announcements; or
4> if the UE is acting as sidelink relay UE; and if SystemInformationBlockType19 includes discConfigRelay; and if the sidelink relay UE threshold conditions as specified in 5.10.10.4 are met; or
4> if the UE is selecting a sidelink relay UE/has a selected sidelink relay UE; and if SystemInformationBlockType19 includes discConfigRelay; and if the sidelink remote UE threshold conditions as specified in 5.10.11.5 are met:
5> initiate transmission of the sidelinkUEInformation message to indicate the PS related sidelink discovery announcement resources required by the UE in accordance with 5.10.2.3;
2> else:
3> if the last transmission of the sidelinkUEInformation message included discTxResourceReqPS:
4> initiate transmission of the sidelinkUEInformation message to indicate it no longer requires PS related sidelink discovery announcement resources in accordance with 5.10.2.3;
2> if configured by upper layers to monitor or transmit sidelink discovery announcements; and if the UE requires sidelink discovery gaps, to perform such actions:
3> if the UE did not transmit a sidelinkUEInformation message since last entering RRC_CONNECTED state; or
3> if since the last time the UE transmitted a sidelinkUEInformation message the UE connected to a PCell not broadcasting SystemInformationBlockType19 or connected to a PCell broadcasting SystemInformationBlockType19 not including gapRequestsAllowedCommon while at the same time the UE was not configured with gapRequestsAllowedDedicated; or
3> if the last transmission of the sidelinkUEInformation message did not include the gaps required to monitor or transmit the sidelink discovery announcements (i.e. UE requiring gaps to monitor discovery announcements while discRxGapReq was not included or UE requiring gaps to transmit discovery announcements while discTxGapReq was not included); or if the sidelink discovery gaps required by the UE have changed (i.e. resulting in a change of discRxGapReq or discTxGapReq) since the last transmission of the sidelinkUEInformation message:
4> if the UE is configured with gapRequestsAllowedDedicated set to true; or
4> if the UE is not configured with gapRequestsAllowedDedicated and gapRequestsAllowedCommon is included in SystemInformationBlockType19:
5> initiate transmission of the sidelinkUEInformation message to indicate the sidelink discovery gaps required by the UE in accordance with 5.10.2.3;
2> else:
3> if the last transmission of the sidelinkUEInformation message included discTxGapReq or discRxGapReq:
4> initiate transmission of the sidelinkUEInformation message to indicate it no longer requires sidelink discovery gaps in accordance with 5.10.2.3;
2> if the UE acquired the relevant parameters from the system information of one or more cells on a carrier included in the discSysInfoToReportConfig and T370 is running:
3> if the UE has configured lower layers to transmit or monitor the sidelink discovery announcements on those cells:
4> initiate transmission of the sidelinkUEInformation message to report the acquired system information parameters and stop T370;
1> if SystemInformationBlockType21 including sl-V2X-ConfigCommon is broadcast by the PCell:
2> ensure having a valid version of SystemInformationBlockType21 for the PCell;
2> if configured by upper layers to receive V2X sidelink communication:
3> if the UE did not transmit a sidelinkUEInformation message since last entering RRC_CONNECTED state; or
3> if since the last time the UE transmitted a sidelinkUEInformation message the UE connected to a PCell not broadcasting SystemInformationBlockType21 including sl-V2X-ConfigCommon; or
3> if the last transmission of the sidelinkUEInformation message did not include v2x-CommRxInterestedFreq; or if the frequency configured by upper layers to receive V2X sidelink communication on has changed since the last transmission of the sidelinkUEInformation message:
4> initiate transmission of the sidelinkUEInformation message to indicate the V2X sidelink communication reception frequency of interest in accordance with 5.10.2.3;
2> else:
3> if the last transmission of the sidelinkUEInformation message included v2x-CommRxInterestedFreq:
4> initiate transmission of the sidelinkUEInformation message to indicate it is no longer interested in V2X sidelink communication reception in accordance with 5.10.2.3;
2> if configured by upper layers to transmit V2X sidelink communication:
3> if the UE did not transmit a sidelinkUEInformation message since last entering RRC_CONNECTED state; or
3> if since the last time the UE transmitted a sidelinkUEInformation message the UE connected to a PCell not broadcasting SystemInformationBlockType21 including sl-V2X-ConfigCommon; or
3> if the last transmission of the sidelinkUEInformation message did not include v2x-CommTxResourceReq; or if the information carried by the v2x-CommTxResourceReq has changed since the last transmission of the sidelinkUEInformation message:
4> initiate transmission of the sidelinkUEInformation message to indicate the V2X sidelink communication transmission resources required by the UE in accordance with 5.10.2.3;
2> else:
3> if the last transmission of the sidelinkUEInformation message included v2x-CommTxResourceReq:
4> initiate transmission of the sidelinkUEInformation message to indicate it no longer requires V2X sidelink communication transmission resources in accordance with 5.10.2.3;
5.10.2.3 Actions related to transmission of sidelinkUEInformation message
The UE shall set the contents of the sidelinkUEInformation message as follows:
1> if the UE initiates the procedure to indicate it is (no more) interested to receive sidelink communication or discovery or receive V2X sidelink communication or to request (configuration/release) of sidelink communication or V2X sidelink communication or sidelink discovery transmission resources (i.e. UE includes all concerned information, irrespective of what triggered the procedure):
2> if SystemInformationBlockType18 is broadcast by the PCell:
3> if configured by upper layers to receive sidelink communication:
4> include commRxInterestedFreq and set it to the sidelink communication frequency;
3> if configured by upper layers to transmit non-relay related one-to-many sidelink communication:
4> include commTxResourceReq and set its fields as follows:
5> set carrierFreq to indicate the sidelink communication frequency i.e. the same value as indicated in commRxInterestedFreq if included;
5> set destinationInfoList to include the non-relay related one-to-many sidelink communication transmission destination(s) for which it requests E-UTRAN to assign dedicated resources;
3> if configured by upper layers to transmit non-relay related one-to-one sidelink communication; and
3> if commTxResourceUC-ReqAllowed is included in SystemInformationBlockType18:
4> include commTxResourceReqUC and set its fields as follows:
5> set carrierFreq to indicate the one-to-one sidelink communication frequency i.e. the same value as indicated in commRxInterestedFreq if included;
5> set destinationInfoList to include the non-relay related one-to-one sidelink communication transmission destination(s) for which it requests E-UTRAN to assign dedicated resources;
3> if configured by upper layers to transmit relay related one-to-one sidelink communication; and
3> if SystemInformationBlockType19 is broadcast by the PCell including discConfigRelay; and
3> if the UE is acting as sidelink relay UE; or if the UE has a selected sidelink relay UE; and if the sidelink remote UE threshold conditions as specified in 5.10.11.5 are met:
4> include commTxResourceReqRelayUC and set its fields as follows:
5> set destinationInfoList to include the one-to-one sidelink communication transmission destination(s) for which it requests E-UTRAN to assign dedicated resources;
4> include ue-Type and set it to relayUE if the UE is acting as sidelink relay UE and to remoteUE otherwise;
3> if configured by upper layers to transmit relay related one-to-many sidelink communication; and
3> if SystemInformationBlockType19 is broadcast by the PCell including discConfigRelay; and
3> if the UE is acting as sidelink relay UE:
4> include commTxResourceReqRelay and set its fields as follows:
5> set destinationInfoList to include the one-to-many sidelink communication transmission destination(s) for which it requests E-UTRAN to assign dedicated resources;
4> include ue-Type and set it to relayUE;
2> if SystemInformationBlockType19 is broadcast by the PCell:
3> if configured by upper layers to receive sidelink discovery announcements on a serving frequency or one or more frequencies included in discInterFreqList, if included in SystemInformationBlockType19:
4> include discRxInterest;
3> if the UE is configured by upper layers to transmit non-PS related sidelink discovery announcements:
4> for each frequency on which the UE is configured to transmit non-PS related sidelink discovery announcements that concerns the primary frequency or that is included in discInterFreqList with discTxResourcesInterFreq included within discResourcesNonPS and not set to noTxOnCarrier:
5> for the first frequency, include discTxResourceReq and set it to indicate the number of discovery messages for sidelink discovery announcement(s) for which it requests E-UTRAN to assign dedicated resources as well as the concerned frequency, if different from the primary;
5> for any additional frequency, include discTxResourceReqAddFreq and set it to indicate the number of discovery messages for sidelink discovery announcement(s) for which it requests E-UTRAN to assign dedicated resources as well as the concerned frequency;
3> if configured by upper layers to transmit PS related sidelink discovery announcements; and
3> if the frequency on which the UE is configured to transmit PS related sidelink discovery announcements either concerns the primary frequency or, in case of non-relay PS related sidelink discovery announcements, is included in discInterFreqList with discTxResources InterFreq included within discResourcesPS and not set to noTxOnCarrier:
4> if configured by upper layers to transmit non-relay PS related sidelink discovery announcements and SystemInformationBlockType19 includes discConfigPS; or
4> if the UE is acting as sidelink relay UE; and if SystemInformationBlockType19 includes discConfigRelay; and if the sidelink relay UE threshold conditions as specified in 5.10.10.4 are met; or
4> if the UE is selecting a sidelink relay UE/has a selected sidelink relay UE; and if SystemInformationBlockType19 includes discConfigRelay; and if the sidelink remote UE threshold conditions as specified in 5.10.11.5 are met:
5> include discTxResourceReqPS and set it to indicate the number of discovery messages for PS related sidelink discovery announcement(s) for which it requests E-UTRAN to assign dedicated resources as well as the concerned frequency, if different from the primary;
2> if SystemInformationBlockType21 is broadcast by the PCell and SystemInformationBlockType21 includes sl-V2X-ConfigCommon:
3> if configured by upper layers to receive V2X sidelink communication:
4> include v2x-CommRxInterestedFreq and set it to the frequency for V2X sidelink communication;
3> if configured by upper layers to transmit V2X sidelink communication:
4> include v2x-CommTxResourceReq and set its fields as follows:
5> set v2x-CommTxFreq to indicate the frequency for V2X sidelink communication i.e. the same value as indicated in v2x-CommRxInterestedFreq if included;
5> set v2x-DestinationInfoList to include the V2X sidelink communication transmission destination(s) for which it requests E-UTRAN to assign dedicated resources;
1> else if the UE initiates the procedure to request sidelink discovery transmission and/or reception gaps:
2> if the UE is configured with gapRequestsAllowedDedicated set to true; or
2> if the UE is not configured with gapRequestsAllowedDedicated and gapRequestsAllowedCommon is included in SystemInformationBlockType19:
3> if the UE requires sidelink discovery gaps to monitor the sidelink discovery announcements the UE is configured to monitor by upper layers:
4> include discRxGapReq and set it to indicate, for each frequency that either concerns the primary frequency or is included in discInterFreqList on which the UE is configured to monitor sidelink discovery announcements and for which it requires sidelink discovery gaps to do so, the gap pattern(s) as well as the concerned frequency, if different from the primary;
3> if the UE requires sidelink discovery gaps to transmit the sidelink discovery announcements the UE is configured to transmit by upper layers:
4> include discTxGapReq and set it to indicate, for each frequency that either concerns the primary or is included in discInterFreqList on which the UE is configured to transmit sidelink discovery announcements and for which it requires sidelink discovery gaps to do so, the gap pattern(s) as well as the concerned frequency, if different from the primary;
1> else if the UE initiates the procedure to report the system information parameters related to sidelink discovery of carriers other than the primary:
2> include discSysInfoReportFreqList and set it to report the system information parameter acquired from the cells on those carriers;
The UE shall submit the sidelinkUEInformation message to lower layers for transmission.
5.10.3 sidelink communication monitoring
A UE capable of sidelink communication that is configured by upper layers to receive sidelink communication shall:
1> if the conditions for sidelink communication operation as defined in 5.10.1a are met:
2> if in coverage on the frequency used for sidelink communication, as defined in TS 36.304 [4, 11.4]:
3> if the cell chosen for sidelink communication reception broadcasts SystemInformationBlockType18 including commRxPool:
4> configure lower layers to monitor sidelink control information and the corresponding data using the pool of resources indicated by commRxPool;
NOTE 1: If commRxPool includes one or more entries including rxParametersNCell, the UE may only monitor such entries if the associated PSS/SSS or SLSSIDs is detected. When monitoring such pool(s), the UE applies the timing of the concerned PSS/SSS or SLSS.
2> else (i.e. out of coverage on the sidelink carrier):
3> configure lower layers to monitor sidelink control information and the corresponding data using the pool of resources that were preconfigured (i.e. preconfigComm in SL-P reconfiguration defined in 9.3);
NOTE 2: The UE may monitor in accordance with the timing of the selected SyncRef UE, or if the UE does not have a selected SyncRef UE, based on the UE's own timing.
5.10.4 sidelink communication transmission
A UE capable of sidelink communication that is configured by upper layers to transmit non-relay related sidelink communication and has related data to be transmitted or a UE capable of relay related sidelink communication that is configured by upper layers to transmit relay related sidelink communications and satisfies the conditions for relay related sidelink communication specified in this section shall:
1> if the conditions for sidelink communication operation as defined in 5.10.1a are met:
2> if in coverage on the frequency used for sidelink communication, as defined in TS 36.304 [4, 11.4]:
3> if the UE is in RRC_CONNECTED and uses the PCell for sidelink communication:
4> if the UE is configured, by the current PCell/the PCell in which physical layer problems or radio link failure was detected, with commTxResources set to scheduled:
5> if T310 or T311 is running; and if the PCell at which the UE detected physical layer problems or radio link failure broadcasts SystemInformationBlockType18 including commTxPoolExceptional; or
5> if T301 is running and the cell on which the UE initiated connection re-establishment broadcasts SystemInformationBlockType18 including commTxPoolExceptional:
6> configure lower layers to transmit the sidelink control information and the corresponding data using the pool of resources indicated by the first entry in commTxPoolExceptional;
5> else:
6> configure lower layers to request E-UTRAN to assign transmission resources for sidelink communication;
4> else if the UE is configured with commTxPoolNormalDedicated or commTxPoolNormalDedicatedExt:
5> if priorityList is included for the entries of commTxPoolNormalDedicated or commTxPoolNormalDedicatedExt:
6> configure lower layers to transmit the sidelink control information and the corresponding data using the one or more pools of resources indicated by commTxPoolNormalDedicated or commTxPoolNormalDedicatedExt i.e. indicate all entries of this field to lower layers;
5> else:
6> configure lower layers to transmit the sidelink control information and the corresponding data using the pool of resources indicated by the first entry in commTxPoolNormalDedicated;
3> else (i.e. sidelink communication in RRC_IDLE or on cell other than PCell in RRC_CONNECTED):
4> if the cell chosen for sidelink communication transmission broadcasts SystemInformationBlockType18:
5> if SystemInformationBlockType18 includes commTxPoolNormalCommon:
6> if priorityList is included for the entries of commTxPoolNormalCommon or commTxPoolNormalCommonExt:
7> configure lower layers to transmit the sidelink control information and the corresponding data using the one or more pools of resources indicated by commTxPoolNormalCommon and/or commTxPoolNormalCommonExt i.e. indicate all entries of these fields to lower layers;
6> else:
7> configure lower layers to transmit the sidelink control information and the corresponding data using the pool of resources indicated by the first entry in commTxPoolNormalCommon;
5> else if SystemInformationBlockType18 includes commTxPoolExceptional:
6> from the moment the UE initiates connection establishment until receiving an RRCConnectionReconfiguration including sl-CommConfig or until receiving an RRCConnectionRelease or an RRCConnectionReject;
7> configure lower layers to transmit the sidelink control information and the corresponding data using the pool of resources indicated by the first entry in commTxPoolExceptional;
2> else (i.e. out of coverage on sidelink carrier):
3> if priorityList is included for the entries of preconfigComm in SL-Preconfiguration defined in 9.3:
4> configure lower layers to transmit the sidelink control information and the corresponding data using the one or more pools of resources indicated preconfigComm i.e. indicate all entries of this field to lower layers and in accordance with the timing of the selected SyncRef UE, or if the UE does not have a selected SyncRef UE, based on the UEs own timing;
3> else:
4> configure lower layers to transmit the sidelink control information and the corresponding data using the pool of resources that were preconfigured i.e. indicated by the first entry in preconfigComm in SL-P reconfiguration defined in 9.3 and in accordance with the timing of the selected SyncRef UE, or if the UE does not have a selected SyncRef UE, based on the UEs own timing;
The conditions for relay related sidelink communication are as follows:
1> if the transmission concerns sidelink relay communication; and the UE is capable of sidelink relay or sidelink remote operation:
2> if the UE is in RRC_IDLE; and if the UE has a selected sidelink relay UE: configure lower layers to transmit the sidelink control information and the corresponding data using the resources, as specified previously in this section, only if the following condition is met:
3> if the sidelink remote UE threshold conditions as specified in 5.10.11.5 are met; and if the UE configured lower layers with a pool of resources included in SystemInformationBlockType18 (i.e. commTxPoolNormalCommon, commTxPoolNormalCommonExt or commTxPoolExceptional); and commTxAllowRelayCommon is included in SystemInformationBlockType18;
2> if the UE is in RRC_CONNECTED: configure lower layers to transmit the sidelink control information and the corresponding data using the resources, as specified previously in this section, only if the following condition is met:
3> if the UE configured lower layers with resources provided by dedicated signalling (i.e. commTxResources); and the UE is configured with commTxAllowRelayDedicated set to true;
5.10.5 sidelink discovery monitoring
A UE capable of non-PS related sidelink discovery that is configured by upper layers to monitor non-PS related sidelink discovery announcements shall:
1> for each frequency the UE is configured to monitor non-PS related sidelink discovery announcements on, prioritising the frequencies included in discInterFreqList, if included in SystemInformationBlockType19:
2> if the PCell or the cell the UE is camping on indicates the pool of resources to monitor sidelink discovery announcements on by discRxResourcesInterFreq in discResourcesNonPS within discInterFreqList in SystemInformationBlockType19:
3> configure lower layers to monitor sidelink discovery announcements using the pool of resources indicated by discRxResourcesInterFreqin discResourcesNonPS within SystemInformationBlockType19;
2> else if the cell used for sidelink discovery monitoring broadcasts SystemInformationBlockType19:
3> configure lower layers to monitor sidelink discovery announcements using the pool of resources indicated by discRxPool in SystemInformationBlockType19;
2> if the UE is configured with discRxGapConfig and requires sidelink discovery gaps to monitor sidelink discovery announcements on the concerned frequency;
3> configure lower layers to monitor the concerned frequency using the sidelink discovery gaps indicated by discRxGapConfig;
2> else:
3> configure lower layers to monitor the concerned frequency without affecting normal operation;
A UE capable of PS related sidelink discovery that is configured by upper layers to monitor PS related sidelink discovery announcements shall:
1> if out of coverage on the frequency, as defined in TS 36.304 [4, 11.4]:
2> configure lower layers to monitor sidelink discovery announcements using the pool of resources that were preconfigured (i.e. indicated by discRxPoolList within preconfigDisc in SL-P reconfiguration defined in 9.3);
1> else if configured by upper layers to monitor non-relay PS related discovery announcements; and if the PCell or the cell the UE is camping on indicates a pool of resources to monitor sidelink discovery announcements on by discRxResourcesInterFreq in discResourcesPS within discInterFreaList in SystemInformationBlockType19:
2> configure lower layers to monitor sidelink discovery announcements using the pool of resources indicated by discRxResourcesInterFreq in discResourcesPS in SystemInformationBlockType19;
1> else if configured by upper layers to monitor PS related sidelink discovery announcements; and if the cell used for sidelink discovery monitoring broadcasts SystemInformationBlockType19:
2> configure lower layers to monitor sidelink discovery announcements using the pool of resources indicated by discRxPoolPS in SystemInformationBlockType19;
1> if the UE is configured with discRxGapConfig and requires sidelink discovery gaps to monitor sidelink discovery announcements on the concerned frequency;
2> configure lower layers to monitor the concerned frequency using the sidelink discovery gaps indicated by discRxGapConfig;
1> else:
2> configure lower layers to monitor the concerned frequency without affecting normal operation;
NOTE 1: The requirement not to affect normal UE operation also applies for the acquisition of sidelink discovery related system and synchronisation information from inter-frequency cells.
NOTE 2: The UE is not required to monitor all pools simultaneously.
NOTE 3: It is up to UE implementation to decide whether a cell is sufficiently good to be used to monitor sidelink discovery announcements.
NOTE 4: If discRxPool, discRxPoolPS or discRxResourcesInterFreq includes one or more entries including rxParameters, the UE may only monitor such entries if the associated SLSSIDs are detected. When monitoring such pool(s) the UE applies the timing of the corresponding SLSS.
5.10.6 sidelink discovery announcement
A UE capable of non-PS related sidelink discovery that is configured by upper layers to transmit non-PS related sidelink discovery announcements shall, for each frequency the UE is configured to transmit such announcements on:
NOTE: In case the configured resources are insufficient it is up to UE implementation to decide which sidelink discovery announcements to transmit.
1> if the frequency used to transmit sidelink discovery announcements concerns the serving frequency (RRC_IDLE) or primary frequency (RRC_CONNECTED):
2> if the UE's serving cell (RRC_IDLE) or PCell (RRC_CONNECTED) is suitable as defined in TS 36.304 [4]:
3> if the UE is in RRC_CONNECTED (i.e. PCell is used for sidelink discovery announcement):
4> if the UE is configured with discTxResources set to scheduled:
5> configure lower layers to transmit the sidelink discovery announcement using the assigned resources indicated by scheduled in discTxResources;
4> else if the UE is configured with discTxPoolDedicated (i.e. discTxResources set to ue-Selected):
5> select an entry of the list of resource pool entries in discTxPoolDedicated and configure lower layers to use it to transmit the sidelink discovery announcements as specified in 5.10.6a;
3> else if T300 is not running (i.e. UE in RRC_IDLE, announcing via serving cell):
4> if SystemInformationBlockType19 of the serving cell includes discTxPoolCommon:
5> select an entry of the list of resource pool entries in discTxPoolCommon and configure lower layers to use it to transmit the sidelink discovery announcements as specified in 5.10.6a;
1> else if, for the frequency used to transmit sidelink discovery announcements on, the UE is configured with dedicated resources (i.e. with discTxResources-r12, if discTxCarrierFreq is included in discTxInterFreqInfo, or with discTxResources within discTxInfoInterFreqListAdd in discTxInterFreqInfo); and the conditions for non-PS related sidelink discovery operation as defined in 5.10.1c are met:
2> if the UE is configured with discTxResources set to scheduled:
3> configure lower layers to transmit the sidelink discovery announcement using the assigned resources indicated by scheduled in discTxResources;
2> else if the UE is configured with discTxResources set to ue-Selected:
3> select an entry of the list of resource pool entries in ue-Selected and configure lower layers to use it to transmit the sidelink discovery announcements as specified in 5.10.6a;
1> else if the frequency used to transmit sidelink discovery announcements on is included in discInterFreqList within SystemInformationBlockType19 of the serving cell/PCell, and discTxResourcesInterFreq within discResourcesNonPS in the corresponding entry of discInterFreqList is set to discTxPoolCommon (i.e. serving cell/PCell broadcasts pool of resources) and the conditions for non-PS related sidelink discovery operation as defined in 5.10.1c are met; or
1> else if discTxPoolCommon is included in SystemInformationBlockType19 acquired from cell selected on the sidelink discovery announcement frequency; and the conditions for non-PS related sidelink discovery operation as defined in 5.10.1c are met:
2> select an entry of the list of resource pool entries in discTxPoolCommon and configure lower layers to use it to transmit the sidelink discovery announcements as specified in 5.10.6a;
1> if the UE is configured with discTxGapConfig and requires sidelink discovery gaps to transmit sidelink discovery announcements on the concerned frequency;
2> configure lower layers to transmit on the concerned frequency using the sidelink discovery gaps indicated by discTxGapConfig,
1> else:
2> configure lower layers to transmit on the concerned frequency without affecting normal operation;
A UE capable of PS related sidelink discovery that is configured by upper layers to transmit PS related sidelink discovery announcements shall:
1> if out of coverage on the frequency used to transmit PS related sidelink discovery announcements as defined in TS 36.304 [4, 11.4] and the conditions for PS-related sidelink discovery operation as defined in 5.10.1b are met:
2> if configured by upper layers to transmit non-relay PS related sidelink discovery announcements; or
2> if the UE is selecting a sidelink relay UE/has a selected sidelink relay UE:
3> configure lower layers to transmit sidelink discovery announcements using the pool of resources that were preconfigured and in accordance with the following;
4> randomly select, using a uniform distribution, an entry of preconfigDisc in SL-Preconfiguration defined in 9.3;
4> using the timing of the selected SyncRef UE, or if the UE does not have a selected SyncRef UE, based on the UEs own timing;
1> else if the frequency used to transmit sidelink discovery announcements concerns the serving frequency (RRC_IDLE) or primary frequency (RRC_CONNECTED) and the conditions for PS related sidelink discovery operation as defined in 5.10.1b are met:
2> if configured by upper layers to transmit non-relay PS related sidelink discovery announcements; or
2> if the UE is acting as sidelink relay UE; and if the UE is in RRC_IDLE; and if the sidelink relay UE threshold conditions as specified in 5.10.10.4 are met; or
2> if the UE is acting as sidelink relay UE; and if the UE is in RRC_CONNECTED; or
2> if the UE is selecting a sidelink relay UE/has a selected sidelink relay UE; and if the sidelink remote UE threshold conditions as specified in 5.10.11.5 are met:
3> if the UE is configured with discTxPoolPS-Dedicated; or
3> if the UE is in RRC_IDLE; and if discTxPoolPS-Common is included in SystemInformationBlockType19:
4> select an entry of the list of resource pool entries and configure lower layers to use it to transmit the sidelink discovery announcements as specified in 5.10.6a;
3> else if the UE is configured with discTxResourcesPS set to scheduled:
4> configure lower layers to transmit the sidelink discovery announcement using the assigned resources indicated by scheduled in discTxResourcesPS;
1> else if, for the frequency used to transmit sidelink discovery announcements on, the UE is configured with dedicated resources (i.e. with discTxResourcesPS in discTxInterFreqInfo within sl-DiscConfig); and the conditions for PS related sidelink discovery operation as defined in 5.10.1b are met:
2> if configured by upper layers to transmit non-relay PS related sidelink discovery announcements:
3> if the UE is configured with discTxResourcesPS set to scheduled:
4> configure lower layers to transmit the sidelink discovery announcement using the assigned resources indicated by scheduled in discTxResourcesPS;
3> else if the UE is configured with discTxResourcesPS set to ue-Selected:
4> select an entry of the list of resource pool entries in ue-Selected and configure lower layers to use it to transmit the sidelink discovery announcements as specified in 5.10.6a;
1> else if the frequency used to transmit sidelink discovery announcements on is included in discInterFreqList within SystemInformationBlockType19 of the serving cell/PCell, while discTxResourcesInterFreq within discResourcesPS in the corresponding entry of discInterFreqList is set to discTxPoolCommon (i.e. serving cell/PCell broadcasts pool of resources) and the conditions for PS related sidelink discovery operation as defined in 5.10.1b are met:
2> if configured by upper layers to transmit non-relay PS related sidelink discovery announcements:
3> select an entry of the list of resource pool entries in discTxPoolCommon and configure lower layers to use it to transmit the sidelink discovery announcements as specified in 5.10.6a;
1> else if discTxPoolPS-Common is included in SystemInformationBlockType19 acquired from cell selected on the sidelink discovery announcement frequency; and the conditions for PS related sidelink discovery operation as defined in 5.10.1b are met:
2> if configured by upper layers to transmit non-relay PS related sidelink discovery announcements:
3> select an entry of the list of resource pool entries in discTxPoolPS-Common and configure lower layers to use it to transmit the sidelink discovery announcements as specified in 5.10.6a;
1> if the UE is configured with discTxGapConfig and requires gaps to transmit sidelink discovery announcements on the concerned frequency;
2> configure lower layers to transmit on the concerned frequency using the gaps indicated by discTxGapConfig,
1> else:
2> configure lower layers to transmit on the concerned frequency without affecting normal operation;
5.10.6a sidelink discovery announcement pool selection
A UE that is configured with a list of resource pool entries for sidelink discovery announcement transmission (i.e. by SL-DiscTxPoolList) shall:
1> if poolSelection is set to rsrpBased:
2> select a pool from the list of pools the UE is configured with for which the RSRP measurement of the reference cell selected as defined in 5.10.6b, after applying the layer 3 filter defined by quantityConfig as specified in 5.5.3.2, is in-between threshLow and threshHigh;
1> else:
2> randomly select, using a uniform distribution, a pool from the list of pools the UE is configured with;
1> configure lower layers to transmit the sidelink discovery announcement using the selected pool of resources;
NOTE 1: When performing resource pool selection based on RSRP, the UE uses the latest results of the available measurements used for cell reselection evaluation in RRC_IDLE/for measurement report triggering evaluation in RRC_CONNECTED, which are performed in accordance with the performance requirements specified in TS 36.133 [16].
5.10.6b sidelink discovery announcement reference carrier selection
A UE capable of sidelink discovery that is configured by upper layers to transmit sidelink discovery announcements shall:
1> for each frequency the UE is transmitting sidelink discovery announcements on, select a cell to be used as reference for synchronisation and DL measurements in accordance with the following:
2> if the frequency concerns the primary frequency:
3> use the PCell as reference;
2> else if the frequency concerns a secondary frequency:
3> use the concerned SCell as reference;
2> else if the UE is configured with discTxRefCarrierDedicated for the frequency:
3> use the cell indicated by this field as reference;
2> else if the UE is configured with refCarrierCommon for the frequency:
3> use the serving cell (RRC_IDLE)/PCell (RRC_CONNECTED) as reference;
2> else:
3> use the DL frequency paired with the one used to transmit sidelink discovery announcements on as reference;
5.10.12 V2X sidelink communication monitoring
A UE capable of V2X sidelink communication that is configured by upper layers to receive V2X sidelink communication shall:
1> if the conditions for sidelink operation as defined in 5.10.1d are met:
2> if in coverage on the frequency used for V2X sidelink communication, as defined in TS 36.304 [4, 11.4]:
3> if the cell chosen for V2X sidelink communication reception broadcasts SystemInformationBlockType21 including v2x-CommRxPool included in sl-V2X-ConfigCommon or,
3> if the UE is configured with v2x-CommRxPool included in mobilityControlInfoV2X in RRCConnectionReconfiguration:
4> configure lower layers to monitor sidelink control information and the corresponding data using the pool of resources indicated;
2> else (i.e. out of coverage on the carrier for V2X sidelink communication):
3> configure lower layers to monitor sidelink control information and the corresponding data using the pool of resources that were preconfigured (i.e. v2x-CommRxPoolList in SL-V2X-Preconfiguration defined in 9.3);
5.10.13 V2X sidelink communication transmission
5.10.13.1 Transmission of V2X sidelink communication
A UE capable of V2X sidelink communication that is configured by upper layers to transmit V2X sidelink communication and has related data to be transmitted shall:
1> if the conditions for sidelink operation as defined in 5.10.1d are met:
2> if in coverage on the frequency used for V2X sidelink communication as defined in TS 36.304 [4, 11.4]; or
2> if the frequency used to transmit V2X sidelink communication is included in v2x-InterFreqInfoList in RRCConnectionReconfiguration or in v2x-InterFreqInfoList within SystemInformationBlockType21:

### 3> if the UE is in RRC_CONNECTED:

4> if the UE is configured, by the current PCell with commTxResources set to scheduled:
5> if T310 or T311 is running; and if the PCell at which the UE detected physical layer problems or radio link failure broadcasts SystemInformationBlockType21 including v2x-CommTxPoolExceptional in sl-V2X-ConfigCommon; or
5> if T301 is running and the cell on which the UE initiated connection re-establishment broadcasts SystemInformationBlockType21 including v2x-CommTxPoolExceptional in sl-V2X-ConfigCommon:
6> configure lower layers to transmit the sidelink control information and the corresponding data based on sensing using the pool of resources indicated by v2x-CommTxPoolExceptional as defined in TS 36.321 [6] and TS 36.213 [23].
NOTE 1: The UE is assumed to perform sensing on the resources of the pool (as defined in TS 36.213 [23]) indicated by v2x-CommTxPoolExceptional within SystemInformationBlockType21, before it transmits using the pool of resources.
5> if T304 is running and the UE is configured with v2x-CommTxPoolExceptional included in mobilityControlInfoV2X in RRCConnectionReconfiguration:
6> configure lower layers to transmit the sidelink control information and the corresponding data based on random selection using the pool of resources indicated by v2x-CommTxPoolExceptional as defined in TS 36.321 [6];
5> else:
6> configure lower layers to request E-UTRAN to assign transmission resources for V2X sidelink communication;
4> else if the UE is configured with v2x-commTxPoolNormalDedicated in RRCConnectionReconfiguration:
5> if the time required by the physical layer in TS 36.213 [23] for sensing on the resources configured in v2x-CommTxPoolNormalDedicated is not met;
6> if v2x-CommTxPoolExceptional is included in mobilityControlInfoV2X in RRCConnectionReconfiguration (i.e., handover case);
7> configure lower layers to transmit the sidelink control information and the corresponding data based on random selection using the pool of resources indicated by v2x-CommTxPoolExceptional as defined in TS 36.321 [6];
6> else if the Pcell broadcasts SystemInformationBlockType21 including v2x-CommTxPoolExceptional in sl-V2X-ConfigCommon;
7> configure lower layers to transmit the sidelink control information and the corresponding data based on sensing using the pool of resources indicated by v2x-CommTxPoolExceptional as defined in TS 36.321 [6] and TS 36.213 [23];
5> else:
6> configure lower layers to transmit the sidelink control information and the corresponding data based on sensing (as defined in TS 36.321 [6] and TS 36.213 [23]) using one of the resource pools indicated by v2x-commTxPoolNormalDedicated, which is selected according to 5.10.13.2;
3> else (i.e. V2X sidelink communication in RRC_IDLE or on cell other than PCell in RRC_CONNECTED):
4> if the cell chosen for V2X sidelink communication transmission broadcasts SystemInformationBlockType21:
5> if SystemInformationBlockType21 includes v2x-CommTxPoolNormalCommon in sl-V2X-ConfigCommon:
6> configure lower layers to transmit the sidelink control information and the corresponding data based on sensing (as defined in TS 36.321 [6] and TS 36.213 [23]) using one of the resource pools indicated by v2x-CommTxPoolNormalCommon, which is selected according to 5.10.13.2;
5> else if SystemInformationBlockType21 includes v2x-CommTxPoolExceptional in sl-V2X-ConfigCommon:
6> from the moment the UE initiates connection establishment until receiving an RRCConnectionReconfiguration including sl-V2X-ConfigDedicated or until receiving an RRCConnectionRelease or an RRCConnectionReject;
7> configure lower layers to transmit the sidelink control information and the corresponding data based on sensing (as defined in TS 36.321 [6] and TS 36.213 [23]) using the pool of resources indicated in v2x-CommTxPoolExceptional;
2> else (i.e. out of coverage on sidelink carrier):
3> configure lower layers to transmit the sidelink control information and the corresponding data based on sensing (as defined in TS 36.321 [6] and TS 36.213 [23]) using one of the resource pools indicated by v2x-CommTxPoolList in SL-V2X-Preconfiguration, which is selected according to 5.10.13.2, and in accordance with the timing of the selected reference as defined in 5.10.8;
5.10.13.2 V2X sidelink communication transmission pool selection
The UE configured by upper layers for V2X sidelink communication shall only use the pool which corresponds to geographical coordinates of the UE, if zoneConfig is included in SystemInformationBlockType21 of the serving cell (RRC_IDLE)/Pcell (RRC_CONNECTED) and the UE is configured to use resource pools provided by RRC signaling; or zoneConfig is included in SL-V2X-Preconfiguration, and the UE is configured to use resource pools in SL-V2X-Preconfiguration, according to 5.10.13.1.
If zoneConfig is not included in SystemInformationBlockType21, the UE which is configured to transmit on v2x-CommTxPoolNormalCommon according to 5.10.13.1 shall select the first entry of v2x-CommTxPoolNormalCommon; and the UE which is configured to transmit on the pools in v2x-CommTxPoolNormalDedicated according to 5.10.13.1 shall use the first pool included in v2x-CommTxPoolNormalDedicated.
The UE shall determine an identity of the zone (i.e. Zone_id) in which it is located using the following formulae, if zoneConfig is included in SystemInformationBlockType21 or in SL-V2X-Preconfiguration:

x₁=Floor(x/L)Mod Nx;

y₁=Floor(y/W)Mod Ny;

Zone_id=y₁*Nx+x₁.

The parameters in the formulae are defined as follows:
L is the value of zoneLength included in zoneConfig in SystemInformationBlockType21 or in SL-V2X-P reconfiguration;
W is the value of zoneWidth included in zoneConfig in SystemInformationBlockType21 or in SL-V2X-Preconfiguration;
Nx is the value of zoneIdLongiMod included in zoneConfig in SystemInformationBlockType21 or in SL-V2X-Preconfiguration;
Ny is the value of zondeIdLatiMod included in zoneConfig in SystemInformationBlockType21 or in SL-V2X-Preconfiguration;
x is the distance in longitude between UE's current location and geographical coordinates (0, 0) and it is expressed in meters;
y is the distance in latitude between UE's current location and geographical coordinates (0, 0) and it is expressed in meters.
The UE shall select a pool of resources which includes a zoneID equals to the Zone_id calculated according to above mentioned formulae and indicated by v2x-CommTxPoolNormalDedicated, v2x-CommTxPoolNormalCommon, or v2x-CommTxPoolList according to 5.10.13.1.
NOTE 1: The UE uses its latest geographical coordinates to perform resource pool selection.

System information related to sidelink in LTE are described in 3GPP TS 36.331 v14.1.0:

### SystemInformationBlockType18

The IE SystemInformationBlockType18 indicates E-UTRAN supports the sidelink UE information procedure and may contain sidelink communication related resource configuration information.

SystemInformationBlockType18 information element

-- ASN1START
SystemInformationBlockType18-r12 ::= SEQUENCE {

| | |
|---|---|
| commConfig-r12 | SEQUENCE { |

| | | |
|---|---|---|
| commRxPool-r12 | SL-CommRxPoolList-r12, | |
| commTxPoolNormalCommon-r12 | SL-CommTxPoolList-r12 | OPTIONAL, - |
| - Need OR | | |
| commTxPoolExceptional-r12 | SL-CommTxPoolList-r12 | OPTIONAL, - |
| - Need OR | | |

| | | |
|---|---|---|
| commSyncConfig-r12 | SL-SyncConfigList-r12 | OPTIONAL -- |
| Need OR | | |

| } | | OPTIONAL, - |
|---|---|---|
| - Need OR | | |
| lateNonCriticalExtension | OCTET STRING | OPTIONAL, |
| ..., | | |

| | | |
|---|---|---|
| [[ commTxPoolNormalCommonExt-r13 | SL-CommTxPoolListExt-r13 | OPTIONAL, - |
| - Need OR | | |

| | | |
|---|---|---|
| commTxResourceUC-ReqAllowed-r13 | ENUMERATED {true} | OPTIONAL, -- |
| Need OR | | |

| | | |
|---|---|---|
| commTxAllowRelayCommon-r13 | ENUMERATED {true} | OPTIONAL - |
| - Need OR | | |
| ]] | | |
| } | | |
| -- ASN1STOP | | |

SystemInformationBlockType18 field descriptions

commRxPool
Indicates the resources by which the UE is allowed to receive sidelink communication while in RRC_IDLE and while in
RRC_CONNECTED.
commSyncConfig
Indicates the configuration by which the UE is allowed to receive and transmit synchronisation information. E-UTRAN
configures commSyncConfig including txParameters when configuring UEs by dedicated signalling to transmit
synchronisation information.
commTxAllowRelayCommon
Indicates whether the UE is allowed to transmit relay related sidelink communication data using the transmission pools
included in SystemInformationBlockType18 i.e. either via commTxPoolNormalCommon,
commTxPoolNormalCommonExt or via commTxPoolExceptional.
commTxPoolExceptional
Indicates the resources by which the UE is allowed to transmit sidelink communication in exceptional conditions, as
specified in 5.10.4.
commTxPoolNormalCommon
Indicates the resources by which the UE is allowed to transmit sidelink communication while in RRC_IDLE or when in
RRC_CONNECTED while transmitting sidelink via a frequency other than the primary.
commTxPoolNormalCommonExt
Indicates transmission resource pool(s) in addition to the pool(s) indicated by field commTxPoolNormalCommon, by
which the UE is allowed to transmit sidelink communication while in RRC_IDLE or when in RRC_CONNECTED while
transmitting sidelink via a frequency other than the primary. E-UTRAN configures commTxPoolNormalCommonExt
only when it configures commTxPoolNormalCommon.
commTxResourceUC-ReqAllowed
Indicates whether the UE is allowed to request transmission pools for non-relay related one-to-one sidelink
communication.

### SystemInformationBlockType19

The IE SystemInformationBlockType19 indicates E-UTRAN supports the sidelink UE information procedure and may contain sidelink discovery related resource configuration information.

SystemInformationBlockType19 information element

-- ASN1START
SystemInformationBlockType19-r12 ::= SEQUENCE {

| | |
|---|---|
| discConfig-r12 | SEQUENCE { |

| | | |
|---|---|---|
| discRxPool-r12 | SL-DiscRxPoolList-r12, | |
| discTxPoolCommon-r12 | SL-DiscTxPoolList-r12 | OPTIONAL, - |
| - Need OR | | |

| | | |
|---|---|---|
| discTxPowerInfo-r12 | SL-DiscTxPowerInfoList-r12 | OPTIONAL, -- Cond |
| Tx | | |

| | | |
|---|---|---|
| discSyncConfig-r12 | SL-SyncConfigList-r12 | OPTIONAL -- |
| Need OR | | |

| | |
|---|---|
| } | OPTIONAL, - |
| - Need OR | |

| | | |
|---|---|---|
| discInterFreqList-r12 | SL-CarrierFreqInfoList-r12 | OPTIONAL, -- |
| Need OR | | |

| | | |
|---|---|---|
| lateNonCriticalExtension | OCTET STRING | OPTIONAL, |
| ..., | | |
| [[ discConfig-v1310 | SEQUENCE { | |

| | | |
|---|---|---|
| discInterFreqList-v1310 | SL-CarrierFreqInfoList-v1310 | OPTIONAL, - |
| - Need OR | | |

| | | |
|---|---|---|
| gapRequestsAllowedCommon | ENUMERATED {true} | OPTIONAL -- |
| Need OR | | |

| | |
|---|---|
| } | OPTIONAL, -- |
| Need OR | |

| | |
|---|---|
| discConfigRelay-r13 | SEQUENCE { |

| | |
|---|---|
| relayUE-Config-r13 | SL-DiscConfigRelayUE-r13, |
| remoteUE-Config-r13 | SL-DiscConfigRemoteUE-r13 |

| | |
|---|---|
| } | OPTIONAL, -- |
| Need OR | |

| | |
|---|---|
| discConfigPS-13 | SEQUENCE { |

| | | |
|---|---|---|
| discRxPoolPS-r13 | SL-DiscRxPoolList-r12, | |
| discTxPoolPS-Common-r13 | SL-DiscTxPoolList-r12 | OPTIONAL -- |
| Need OR | | |

| | |
|---|---|
| } | OPTIONAL -- |
| Need OR | |
| ]] | |
| } | |

| | |
|---|---|
| SL-CarrierFreqInfoList-r12 ::= | SEQUENCE (SIZE (1..maxFreq)) OF SL-CarrierFreqInfo-r12 |

| | |
|---|---|
| SL-CarrierFreqInfoList-v1310 ::= | SEQUENCE (SIZE (1..maxFreq)) OF SL-CarrierFreqInfo- |
| v1310 | |

| | |
|---|---|
| SL-CarrierFreqInfo-r12::= | SEQUENCE { |

| | |
|---|---|
| carrierFreq-r12 | ARFCN-ValueEUTRA-r9, |

| | | |
|---|---|---|
| plmn-IdentityList-r12 | PLMN-IdentityList4-r12 | OPTIONAL -- Need |
| OP | | |
| } | | |

| | | |
|---|---|---|
| SL-DiscConfigRelayUE-r13 | ::= | SEQUENCE { |

| | | |
|---|---|---|
| threshHigh-r13 | RSRP-RangeSL4-r13 | OPTIONAL, -- Need |
| OR | | |
| threshLow-r13 | RSRP-RangeSL4-r13 | OPTIONAL, -- Need |
| OR | | |

| | | |
|---|---|---|
| hystMax-r13 | ENUMERATED {dB0, dB3, dB6, dB9, dB12, dBinf} | OPTIONAL, - |
| - Cond ThreshHigh | | |

| | | |
|---|---|---|
| hystMin-r13 | ENUMERATED {dB0, dB3, dB6, dB9, dB12} | OPTIONAL -- Cond |
| ThreshLow | | |
| } | | |

| | | |
|---|---|---|
| SL-DiscConfigRemoteUE-r13 | ::= | SEQUENCE { |

| | | |
|---|---|---|
| threshHigh-r13 | RSRP-RangeSL4-r13 | OPTIONAL, -- Need |
| OR | | |
| hystMax-r13 | ENUMERATED {dB0, dB3, dB6, dB9, dB12} | OPTIONAL, -- Cond |
| ThreshHigh | | |
| reselectionInfoIC-r13 | ReselectionInfoRelay-r13 | |
| } | | |

| | |
|---|---|
| ReselectionInfoRelay-r13 ::= | SEQUENCE { |

| | |
|---|---|
| q-RxLevMin-r13 | Q-RxLevMin, |

```
    -- Note that the mapping of invidual values may be different for PC5, but the
granularity/
    -- number of values is same as for Uu
```

| | |
|---|---|
| filterCoefficient-r13 | FilterCoefficient, |

| | |
|---|---|
| minHyst-r13 | ENUMERATED {dB0, dB3, |

dB6, dB9, dB12, dBinf} OPTIONAL -- Need OR

| | |
|---|---|
| } | |
| SL-CarrierFreqInfo-v1310::= | SEQUENCE { |

| | | |
|---|---|---|
| discResourcesNonPS-r13 | SL-ResourcesInterFreq-r13 | OPTIONAL, -- Need |
| OR | | |
| discResourcesPS-r13 | SL-ResourcesInterFreq-r13 | OPTIONAL, -- Need |
| OR | | |

| | | |
|---|---|---|
| discConfigOther-r13 | SL-DiscConfigOtherInterFreq-r13 | OPTIONAL, -- Need |
| OR | | |
| ... | | |
| } | | |

| | |
|---|---|
| PLMN-IdentityList4-r12 ::= | SEQUENCE (SIZE (1..maxPLMN-r11)) OF PLMN-IdentityInfo2-r12 |

| PLMN-IdentityInfo2-r12 ::= | CHOICE { | |
|---|---|---|
| plmn-Index-r12 | | INTEGER (1..maxPLMN-r11), |
| plmnIdentity-r12 | | PLMN-Identity |
| } | | |
| SL-DiscTxResourcesInterFreq-r13 | ::= | CHOICE { |

| acquireSI-FromCarrier-r13 | NULL, | |
|---|---|---|
| discTxPoolCommon-r13 | SL-DiscTxPoolList-r12, | |
| requestDedicated-r13 | NULL, | |
| noTxOnCarrier-r13 | NULL | |
| } | | |
| SL-DiscConfigOtherInterFreq-r13::= | SEQUENCE { | |
| txPowerInfo-r13 | SL-DiscTxPowerInfoList-r12 | OPTIONAL, -- |
| Cond Tx | | |
| refCarrierCommon-r13 | ENUMERATED {pCell} | OPTIONAL, -- |
| Need OR | | |
| discSyncConfig-r13 | SL-SyncConfigListNFreq-r13 | OPTIONAL, -- |
| Need OR | | |
| discCellSelectionInfo-r13 | CellSelectionInfoNFreq-r13 | OPTIONAL -- |
| Need OR | | |
| } | | |

SL-ResourcesInterFreq-r13 ::= SEQUENCE {

| | | |
|---|---|---|
| discRxResourcesInterFreq-r13 | SL-DiscRxPoolList-r12 | OPTIONAL, -- |
| Need OR | | |
| discTxResourcesInterFreq-r13 | SL-DiscTxResourcesInterFreq-r13 | OPTIONAL -- |
| Need OR | | |
| } | | |
| -- ASN1STOP | | |

SystemInformationBlockType19 field descriptions

discCellSelectionInfo
Parameters that may be used by the UE to select/reselect a cell on the concerned non serving frequency. If absent,
the UE acquires the information from the target cell on the concerned frequency. See TS 36.304 [4, 11.4].
discInterFreqList
Indicates the neighbouring frequencies on which sidelink discovery announcement is supported. May also provide
further information i.e. reception resource pool and/or transmission resource pool, or an indication how resources
could be obtained.
discRxPool
Indicates the resources by which the UE is allowed to receive non-PS related sidelink discovery announcements while
in RRC_IDLE and while in RRC_CONNECTED.
discRxPoolPS
Indicates the resources by which the UE is allowed to receive PS related sidelink discovery announcements while in
RRC_IDLE and while in RRC_CONNECTED.
discRxResourcesInterFreq
Indicates the resource pool configuration for receiving discovery announcements on a carrier frequency.
discSyncConfig
Indicates the configuration by which the UE is allowed to receive and transmit synchronisation information. E-UTRAN
configures discSyncConfig including txParameters when configuring UEs by dedicated signalling to transmit
synchronisation information.
discTxPoolCommon
Indicates the resources by which the UE is allowed to transmit non-PS related sidelink discovery announcements
while in RRC_IDLE.
discTxPoolPS-Common
Indicates the resources by which the UE is allowed to transmit PS related sidelink discovery announcements while in
RRC_IDLE.
discTxResourcesInterFreq
For the concerned frequency, either provides the UE with a pool of sidelink discovery announcement transmission
resources the UE is allowed to use while in RRC_IDLE, or indicates whether such transmission is allowed, and if so
how the UE may obtain the required resources. Value noTxOnCarrier indicates that the UE is not allowed to transmit
sidelink discovery announcements on the concerned frequency. Value acquireSI-FromCarrier indicates that the
required resources are to be obtained by autonomously acquiring SIB19 and other relevant SIBs from the concerned
frequency. Value requestDedicated indicates, that for the concerned carrier, the required sidelink discovery resources
are to be obtained by means of a dedicated resource request using the SidelinkUEInformation message.
plmn-IdentityList
List of PLMN identities for the neighbouring frequency indicated by carrierFreq. Absence of the field indicates the
same PLMN identities as listed in plmn-IdentityList (without suffix) in SystemInformationBlockType1.
plmn-Index
Index of the corresponding entry in field plmn-IdentityList (without suffix) within SystemInformationBlockType1.
refCarrierCommon
Indicates if the PCell (RRC_CONNECTED)/serving cell (RRC_IDLE) is to be used as reference for DL measurements
and synchronization, instead of the DL frequency paired with the one used to transmit sidelink discovery
announcements on, see TS 36.213 [23, 14.3.1].
reselectionInfoIC
Includes the parameters used by the UE when selecting/reselecting a sidelink relay UE.
SL-CarrierFreqInfoList-v1310
If included, the UE shall include the same number of entries, and listed in the same order, as in SL-
CarrierFreqInfoList-r12.
threshHigh, threshLow (relayUE)
Indicates when a sidelink remote UE or sidelink relay UE that is in network coverage may use the broadcast PS
related sidelink discovery Tx resource pool, if broadcast, or request Tx resources by dedicated signalling otherwise.
For remote UEs, this parameter is used similarly for relay related sidelink communication.

| Conditional | |
|---|---|
| presence | Explanation |
| ThreshHigh | The field is mandatory present if threshHigh is included |
| | in the corresponding IE. |
| | Otherwise the field is not present and UE shall delete any |
| | existing value for this field. |
| ThreshLow | The field is mandatory present if threshLow is included. |
| | Otherwise the field is not present |
| | UE shall delete any existing value for this field. |
| Tx | The field is mandatory present if discTxPoolCommon is |
| | included. |
| | Otherwise the field is optional present, need OR. |

SystemInformationBlockType 21

The IE SystemInformationBlockType21 contains V2X sidelink communication configuration.

SystemInformationBlockType21 information element

-- ASN1START
SystemInformationBlockType21-r14 ::= SEQUENCE {

| | | |
|---|---|---|
| sl-V2X-ConfigCommon-r14 | SL-V2X-ConfigCommon-r14 | OPTIONAL, -- Need |
| OR | | |
| lateNonCriticalExtension | OCTET STRING | OPTIONAL, |
| ... | | |
| } | | |

SL-V2X-ConfigCommon-r14 ::= SEQUENCE {

| | | |
|---|---|---|
| v2x-CommRxPool-r14 | SL-CommRxPoolListV2X-r14 | OPTIONAL, - |
| - Need OR | | |
| v2x-CommTxPoolNormalCommon-r14 | SL-CommTxPoolListV2X-r14 | OPTIONAL, - |
| - Need OR | | |
| v2x-CommTxPoolExceptional-r14 | SL-CommResourcePoolV2X-r14 | OPTIONAL, - |
| - Need OR | | |
| v2x-SyncConfig-r14 | SL-SyncConfigListV2X-r14 | OPTIONAL, - |
| - Need OR | | |
| v2x-InterFreqInfoList-r14 | SL-InterFreqInfoListV2X-r14 | OPTIONAL, - |
| - Need OR | | |

| | | |
|---|---|---|
| v2x-ResourceSelectionConfig-r14 | SL-CommTxPoolSensingConfig-r14 | OPTIONAL, -- Need OR |

| | | |
|---|---|---|
| zoneConfig-r14 | SL-ZoneConfig-r14 | OPTIONAL - |
| - Need OR | | |
| } | | |
| SL-CommTxPoolSensingConfig-r14 ::= | SEQUENCE { | |

| | |
|---|---|
| pssch-TxConfigList-r14 | SL-PSSCH-TxConfigList-r14, |
| thresPSSCH-RSRP-List-r14 | SL-ThresPSSCH-RSRP-List-r14, |

| | |
|---|---|
| restrictResourceReservationPeriodList-r14 | SL-RestrictResourceReservationPeriodList- |
| r14 OPTIONAL, -- Need OR | |

| | |
|---|---|
| probResourceKeep-r14 | ENUMERATED {v0, v0d0t2, v0d0t4, v0d0t6, v0d0t8, |

spare3,spare2, spare1}

}
-- ASN1STOP

SystemInformationBlockType21 field descriptions

probResourceKeep
Indicates the probability with which the UE keeps the current resource when the resource reselection counter reaches
zero for sensing based UE autonomous resource selection (see TS 36.321 [6]).
pssch-TxConfigList
Indicates PSSCH TX parameters such as MCS, PRB number, retransmission number, which can be associated with
the condition of the UE absolute speed and synchronization reference type in UE autonomous resource selection (see
TS 36.213 [23]).
restrictResourceReservationPeriodList
Indicates which values are allowed for the signaling of the resource reservation period in PSCCH.
thresPSSCH-RSRP-List
Indicates a list of 64 thresholds, and the threshold should be selected based on the priority in the decoded SCI and
the priority in the SCI to be transmitted (see TS 36.213 [23]). A resource is excluded if it is indicated or reserved by a
decoded SCI and PSSCH RSRP in the associated data resource is above a threshold.
v2x-CommRxPool
Indicates the resources by which the UE is allowed to receive V2X sidelink communication while in RRC_IDLE and in
RRC_CONNECTED.
v2x-CommTxPoolExceptional
Indicates the resources by which the UE is allowed to transmit V2X sidelink communication in exceptional conditions,
as specified in 5.10.13.
v2x-CommTxPoolNormalCommon
Indicates the resources by which the UE is allowed to transmit V2X sidelink communication when in RRC_IDLE or
when in RRC_CONNECTED while transmitting V2X sidelink communication via a frequency other than the primary. E-
UTRAN configures one resource pool per zone.
v2x-InterFreqInfoList
Indicates synchronization and resource allocation configurations of neighboring frequencies for V2X sidelink
communication.
v2x-ResourceSelectionConfig
Indicates V2X sidelink communication configurations used for UE autonomous resource selection.
v2x-SyncConfig
Indicates the configuration by which the UE is allowed to receive and transmit synchronisation information for V2X
sidelink communication. E-UTRAN configures v2x-SyncConfig including txParameters when configuring UEs to
transmit synchronisation information.
zoneConfig
Indicates zone configurations used for V2X sidelink communication in 5.10.13.2.

One or more embodiments described herein comprise systems, computer-implemented methods and/or machine-readable storage media for facilitating reporting assistance information for sidelink service in wireless communications systems. In one embodiment, a computer-implemented method for a mobile device is provided. The computer-implemented method can comprise: entering, by the mobile device comprising a processor, a RRC_CONNECTED state; and transmitting, by the mobile device, a first message to a network node after the mobile device enters the RRC_CONNECTED state, wherein the first message includes a first indication for requesting a system information for sidelink and a second indication for requesting transmission resource for a sidelink service.

In one embodiment, a computer-implemented method is provided. The computer-implemented method, comprises: transmitting, by a mobile device comprising a processor, a first sidelink information message in a first serving cell, wherein the mobile device is in a first RRC_CONNECTED state; entering, by the mobile device, a RRC_INACTIVE state from the first RRC_CONNECTED state; transmitting, by the mobile device, a second sidelink information message in a second serving cell when entering a second RRC_CONNECTED state from the RRC_INACTIVE state, based on the mobile device determining that the mobile device is interested in sidelink transmission; and not transmitting, by the mobile device, the second sidelink information message in the second serving cell when entering the second RRC_CONNECTED state from the RRC_INACTIVE state, if the mobile device determines that the mobile device is not interested in sidelink transmission but is interested in sidelink reception.

In one embodiment, a communication device is provided. The communication device comprises a control circuit; a processor coupled to the control circuit; and a memory coupled to the control circuit and operatively coupled to the processor, wherein the processor is configured to execute a program code stored in the memory to perform computer-implemented method steps comprising: entering a RRC CONNECTED state; and transmitting a first message to a network node after entering the RRC_CONNECTED state, wherein the first message includes a first indication for requesting a system information for sidelink and a second indication for requesting transmission resource for a sidelink service.

The exemplary wireless communication systems and devices described below employ a wireless communication system, supporting a broadcast service. Wireless communication systems are widely deployed to provide various types of communication such as voice, data, and so on. These systems can be based on code division multiple access (CDMA), time division multiple access (TDMA), orthogonal frequency division multiple access (OFDMA), 3GPP LTE (Long Term Evolution) wireless access, 3GPP LTE-A (Long Term Evolution Advanced) wireless access, 3GPP2 UMB (Ultra Mobile Broadband), WiMax, 3GPP NR (New Radio), or some other modulation techniques.

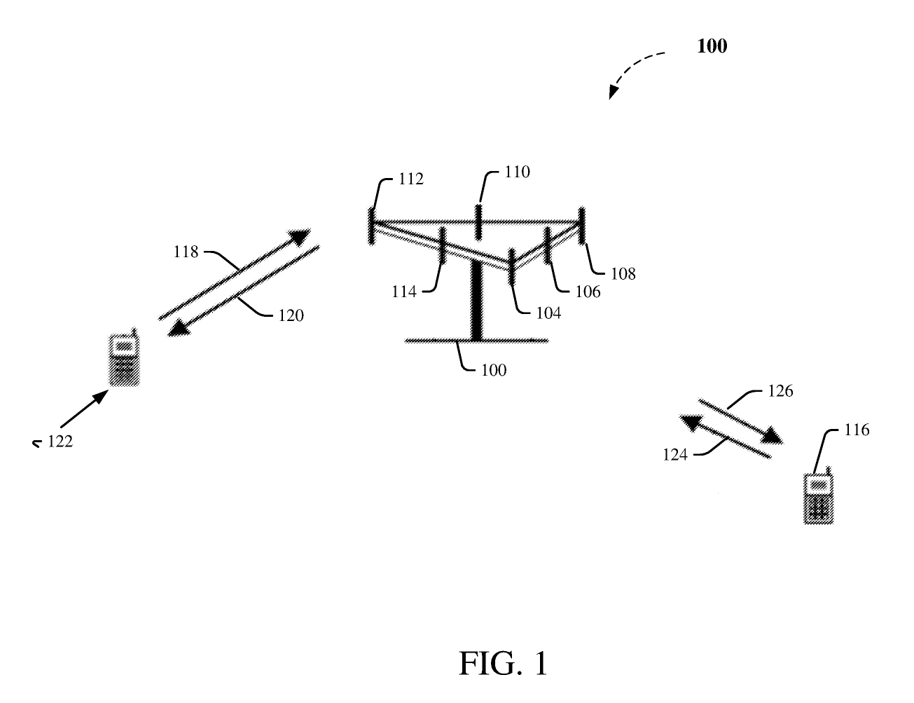

FIG. 1 illustrates an example, non-limiting schematic diagram of a multiple access wireless communication system that facilitates reporting assistance information for sidelink service in accordance with one or more embodiments described herein. In some embodiments, an access network 100 (AN) includes multiple antenna groups (e.g, a first antenna group including antennas 104, 106 and a second antenna group including antennas 108, 110 and a third antenna group including antennas 112, 114.). As used herein, the terms “gNB,” “access network” and “base station” (BS) and “base station device” (BS device) can be interchangeable. Thus, in some embodiments, FIG. 1 can show base station device 100.

In FIG. 1, only two antennas are shown for each antenna group of the BS device 100, however, more or fewer antennas can be utilized for each antenna group. Access Terminal 116 (AT) (which can also be referred to as “mobile device”) can be configured to communicate with one or more of antennas 112, 114, where antennas 112, 114 transmit information to first mobile device over forward link 120 (which is also referred to as the “downlink” or “downlink channel”) and receive information from first mobile device over reverse link 118 (which is also referred to as the “uplink” or “uplink channel”). Second mobile device is in communication with antennas 106 and 108, where antennas 106 and 108 transmit information to second mobile device over downlink channel 126 and receive information from second mobile device over uplink channel 124. In a FDD system, communication links 118, 120, 124 and 126 may use different frequency for communication. For example, downlink channel 120 may use a different frequency than that used by uplink channel 118.

Each group of antennas and/or the area in which the group of antennas is designed to communicate can be often referred to as a “sector” of the BS device. In the embodiment, antenna groups each are designed to communicate to mobile devices in a sector of the areas covered by BS device 100.

In communication over downlink channels 120, 126, the transmitting antennas of BS device 100 can utilize beamforming to improve the signal-to-noise ratio of downlink channels for the different mobile devices 116, 122. Also, BS device 100 using beamforming to transmit to mobile devices scattered randomly through the coverage area of the BS device 100 normally causes less interference to mobile devices in neighboring cells than BS device 100 transmitting through a single antenna to all its mobile devices.

A BS device 100 can be a fixed station or base station used for communicating with the terminals and may also be referred to as an access point, a Node B, an enhanced base station, an eNodeB, or some other terminology. A mobile device may also be called user equipment (UE), a wireless mobile device, terminal, mobile device or some other terminology.

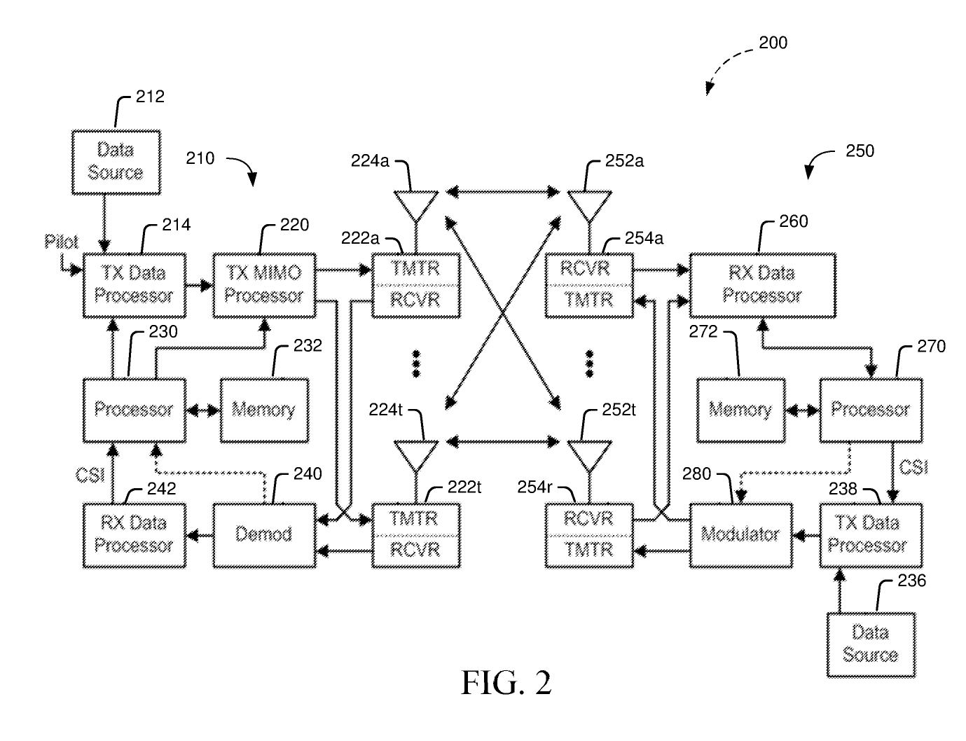

FIG. 2 illustrates an example, non-limiting simplified block diagram of an embodiment of a transmitter) and a receiver system in a multiple input multiple output (MIMO) system in accordance with one or more embodiments described herein. Repetitive description of like elements employed in other embodiments described herein is omitted for sake of brevity.

In some embodiments, as shown, FIG. 2 is a simplified block diagram of an embodiment of a transmitter system 210 and a receiver system 250 (also known as mobile device or user equipment (UE)) in a MIMO system 200. In some embodiments, the transmitter system 210 can be included in the BS device 100 (and/or be the BS device 100). In some embodiments, the receiver system 250 can be (or be included in) the receiver system 250. At the transmitter system 210, traffic data for a number of data streams can be provided from a data source 212 to a transmit (TX) data processor 214.

In one embodiment, each data stream (or, in some embodiments, one or more data streams) is transmitted over a respective transmit antenna. TX data processor 214 formats, codes, and interleaves the traffic data for each data stream based on a particular coding scheme selected for that data stream to provide coded data.

The coded data for each data stream can be multiplexed with pilot data using OFDM techniques. The pilot data is typically a known data pattern that is processed in a known manner and can be used at the receiver system to estimate the channel response. The multiplexed pilot and coded data for each data stream is then modulated (i.e., symbol mapped) based on a particular modulation scheme (e.g., BPSK, QPSK, M-PSK, or M-QAM) selected for that data stream to provide modulation symbols. The data rate, coding, and modulation for each data stream can be determined by instructions performed by processor 230.

The modulation symbols for all data streams are then provided to a TX MIMO processor 220, which may further process the modulation symbols (e.g., for OFDM). TX MIMO processor 220 then provides NT modulation symbol streams to NT transmitters (TMTR) 222a through 222t. In certain embodiments, TX MIMO processor 220 applies beamforming weights to the symbols of the data streams and to the antenna from which the symbol is being transmitted.

In one embodiment, each transmitter 222 receives and processes a respective symbol stream to provide one or more analog signals, and further conditions (e.g., amplifies, filters, and upconverts) the analog signals to provide a modulated signal suitable for transmission over the MIMO channel. NT modulated signals from transmitters 222a through 222t are then transmitted from NT antennas 224a through 224t, respectively.

At receiver system 250, the transmitted modulated signals are received by NR antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the NR received symbol streams from NR receivers 254 based on a particular receiver processing technique to provide NT “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

In some embodiments, the processor 270 periodically determines which pre-coding matrix to use (discussed below). Processor 270 formulates a uplink channel message comprising a matrix index portion and a rank value portion.

The uplink channel message can comprise various types of information regarding the communication link and/or the received data stream. The uplink channel message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

Memory 232 can be used to temporarily store some buffered/computational data from 240 or 242 through processor 230, store some buffed data from 212, or store some specific program codes. Further, memory 272 can be used to temporarily store some buffered/computational data from 260 through processor 270, store some buffed data from 236, or store some specific program codes.

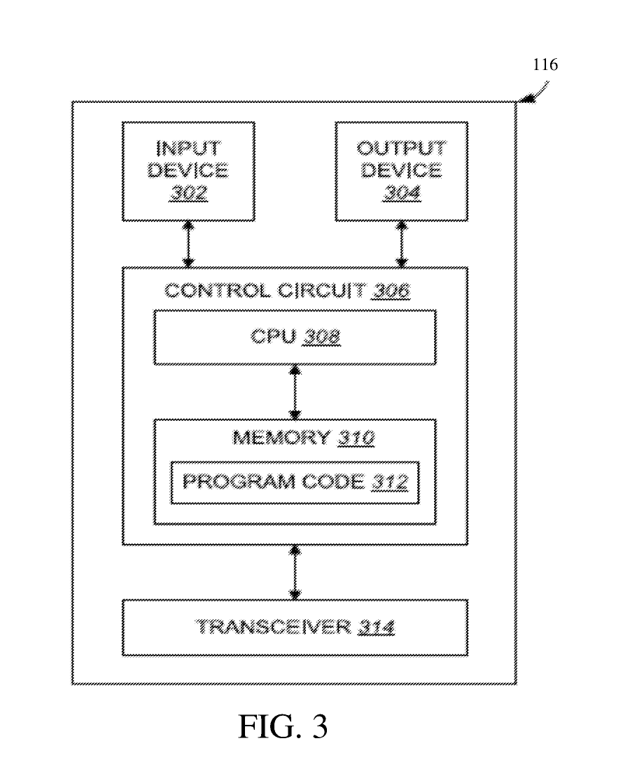

FIG. 3 illustrates an example, non-limiting block diagram of an alternative mobile device for which reporting assistance information for sidelink service can be facilitated in accordance with one or more embodiments described herein. Repetitive description of like elements employed in other embodiments described herein is omitted for sake of brevity.

In some embodiments, the first mobile device in a wireless communication system can include one or more of the function and/or structure of mobile devices 116, 122 in FIG. 1. In some embodiments, the wireless communications system 200 can be the NR system in some embodiments. In other embodiments, the communication system 200 can be other systems other than the NR system. The first mobile device can include an input device 302, an output device 304, a control circuit 306, a central processing unit (CPU) 308, a memory 310, a program code 312, and a transceiver 314. The control circuit 306 can execute the program code 312 in the memory 310 through the CPU 308, thereby controlling an operation of the first mobile device. The first mobile device can receive signals input by a user through the input device 302, such as a keyboard or keypad, and can output images and sounds through the output device 304, such as a monitor or speakers. The transceiver 314 can be used to receive and transmit wireless signals, delivering received signals to the control circuit 306, and outputting signals generated by the control circuit 306 wirelessly.

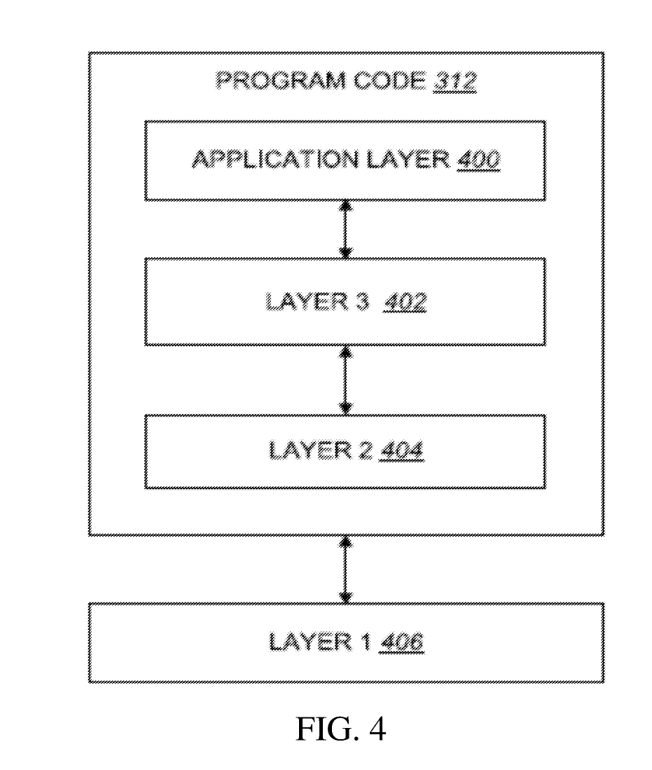

FIG. 4 illustrates an example, non-limiting block diagram of computer program code shown in FIG. 3 that facilitates reporting assistance information for sidelink service in accordance with one or more embodiments described herein. Repetitive description of like elements employed in other embodiments described herein is omitted for sake of brevity.

In some embodiments, FIG. 4 illustrates program code 312 shown in FIG. 3 in accordance with one embodiment of the invention. In this embodiment, the program code 312 includes an application layer 400, a layer 3 portion 402, and a layer 2 portion 404, and is coupled to a layer 1 portion 406. The layer 3 portion 402 generally performs radio resource control. The layer 2 portion 404 generally performs link control. The layer 1 portion 406 generally performs physical connections. For LTE, LTE-A or NR system, the layer 2 portion 404 may include a Radio Link Control (RLC) layer and a Medium Access Control (MAC) layer. The layer 3 portion 402 can include a Radio Resource Control (RRC) layer.

While FIG. 2 showed one embodiment of a transmitter system 210, which can be included in BS device 100, in another embodiment, the transmitter system 210 can be or include BS device 100. Similarly, while FIG. 2 showed one embodiment of a reception system 250, which can be included in first mobile device, in another embodiment, the transmitter system 210 can be or include first mobile device.

FIG. 5 illustrates an example, non-limiting block diagram of a mobile device for which reporting assistance information for sidelink service can be facilitated in accordance with one or more embodiments described herein. Repetitive description of like elements employed in other embodiments described herein is omitted for sake of brevity.

First mobile device can comprise communication component 502, sideline control component 504, memory 506 and/or processor 508. In various embodiments, one or more of communication component 502, sideline control component 504, memory 506 and/or processor 508 can be electrically and/or communicatively coupled to one another to perform one or more functions of first mobile device (or 122). In some embodiments, memory 506 can store computer readable storage media and/or computer executable instructions or computer executable code that can be executed on processor 508 to perform one or more functions of first mobile device. One or more embodiments will be described with reference to BS device 100 and/or mobile devices 116, 122 (or components thereof) as noted in FIGS. 1, 2, 3, 4 and/or 5. In various embodiments, one or more of the structure and/or functionality of the first mobile device can be the same as the functionality and/or structure of second mobile device.

As used herein, the term “sidelink information message” (e.g., sidelinkUEInformation in 3GPP TS 36.331 v14.1.0) can mean a message used to notify the gNB (e.g., BS device 100) that the first mobile device is interested in sidelink service(s) and/or a message used to request/release resource assignment of sidelink transmission. The sidelink service can be sidelink communication transmission, sidelink communication reception, sidelink discovery transmission, sidelink discovery reception, or etc. A mobile device could have more than one sidelink service at a time. The sidelink transmission can be sidelink discovery transmission, sidelink communication transmission, etc.

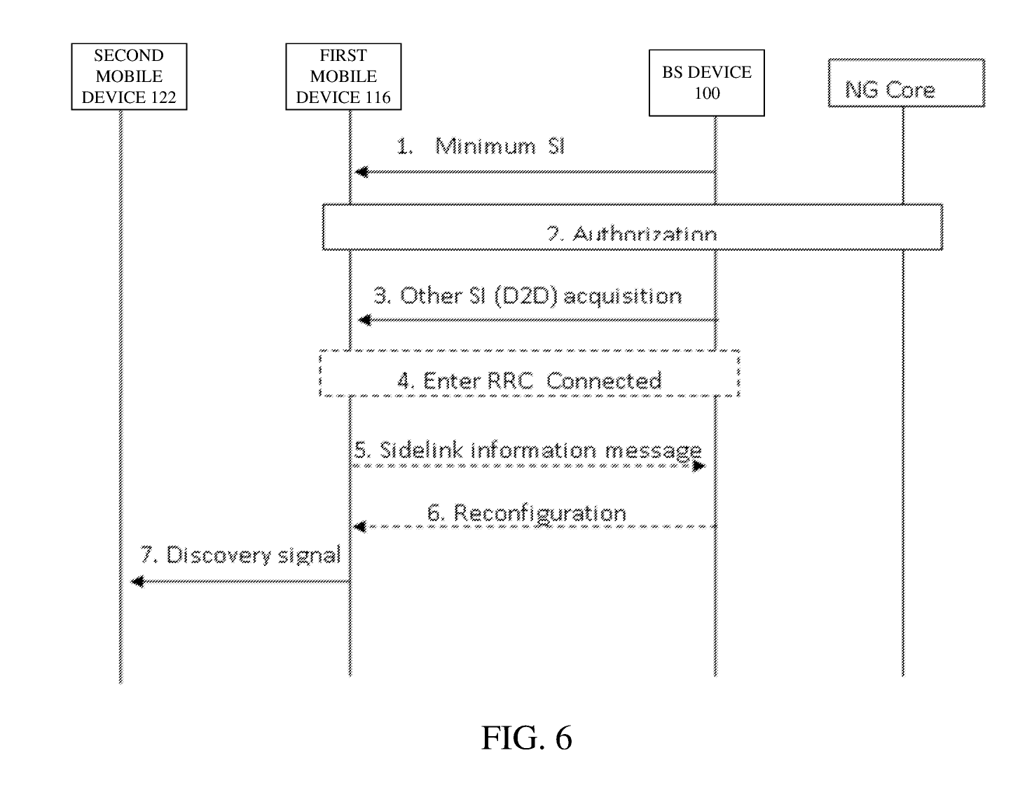

FIG. 6 illustrates an example, non-limiting flow diagram showing the steps for performing discovery transmission to facilitate reporting assistance information for sidelink service in accordance with one or more embodiments described herein. In some embodiments, the discovery transmission can be sidelink discovery transmission. One or more steps can be performed by sidelink control component 504 in various embodiments. The flow diagram can show an example of sidelink discovery transmission. Both a first mobile device (e.g., first mobile device 116) and a second mobile device (e.g., second mobile device 122) are capable of transmitting a sidelink discovery message. The first mobile device can be located within a cell controlled by a gNB (e.g., BS device 100). The second mobile device can be also within the cell or another cell controlled by the gNB (e.g., BS device 100) or another gNB (not shown). The second mobile device can be in the proximity of the first mobile device such that second mobile device and first mobile device can communicate with each other directly and/or via a gNB in various different embodiments.

At step 1, when first mobile device is powered on, first mobile device performs cell selection and then camps on a serving cell. The first mobile device receives the minimum SI from a gNB of the serving cell (e.g., in this case, from BS device 100). At step 2, the first mobile device performs an authorization procedure with core network (e.g., NR core network, CN, NR Core) for getting authority and information to perform sidelink service. As used herein, the term “sidelink service” can be sidelink communication transmission, sidelink communication reception, sidelink discovery transmission, sidelink discovery reception, etc.

At Step 3, first, the first mobile device checks whether the serving cell supports sidelink service. The first mobile device will acquire system information related to device-to-device (sidelink) service based on a particular procedure (e.g., preamble transmission and/or random access like procedure), if the first mobile device is in RRC_IDLE state. Else, if the first mobile device is in RRC_CONNECTED state, the first mobile device can send a system information request RRC message to the network (e.g., gNB, which can also be considered BS device 100 of FIG. 1) for obtaining valid discovery system information.

At Step 4, if the first mobile device is released to RRC_IDLE state and no transmission resource pool is provided for first mobile device in RRC_IDLE state, the first mobile device will need to enter RRC_CONNECTED state for requesting transmission resource.

At Step 5, if the first mobile device is in RRC_CONNECTED state, the first mobile device will send a sidelink information message (e.g., sidelinkUEInformation) to the network (e.g., gNB) for requesting transmission resource and/or informing network other assistance information (e.g., frequency).

At Step 6, the network can allocate transmitting resource pool in a dedicated RRC message (e.g., reconfiguration). The network may provide one or multiple transmitting resource pools. The network allocates receiving pool through other SI.

At Step 7, the first mobile device can perform data transmission based on resource allocation in step 6, if the first mobile device is in the RRC_CONNECTED state, or based on transmission resource pool provided in other SI for D2D/sidelink service, if the first mobile device is in RRC_IDLE state.

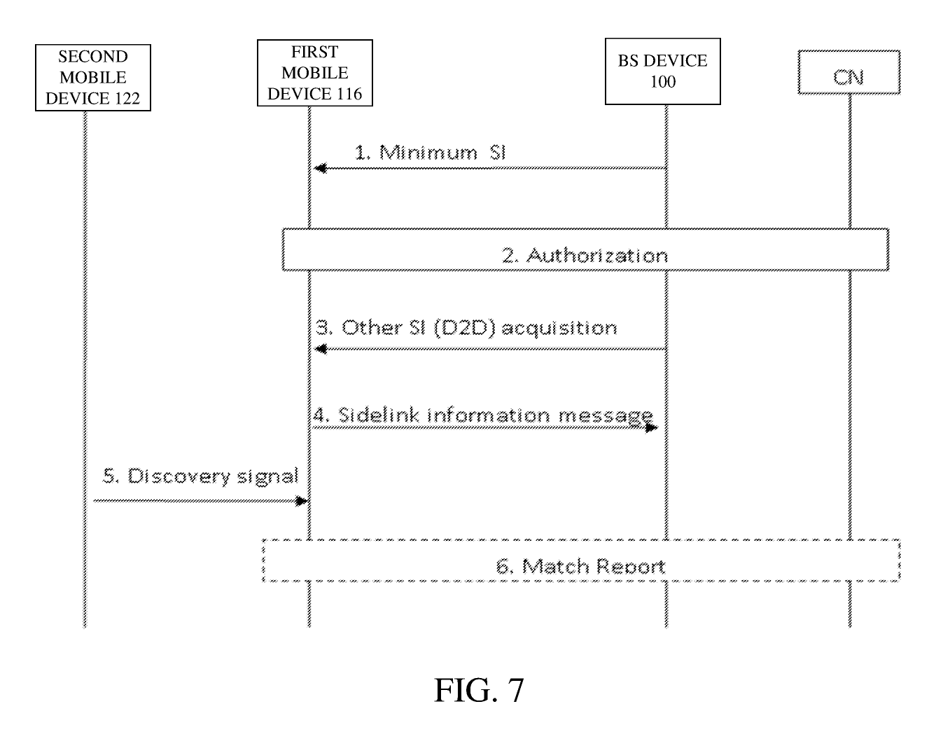

FIG. 7 illustrates an example, non-limiting flow diagram showing the steps for performing discovery reception to facilitate reporting assistance information for sidelink service in accordance with one or more embodiments described herein. In some embodiments, the discovery reception can be sidelink discovery reception. One or more steps can be performed by sidelink control component 504 in various embodiments. FIG. 7 can illustrate the flow of this scenario. Both first mobile device and second mobile device can be capable of receiving a sidelink discovery message. The first mobile device is within a cell controlled by a gNB (e.g., BS device 100). The second mobile device can be also within the cell or another cell controlled by the gNB (e.g., BS device 100) or another gNB (e.g., not shown). The first mobile device is in the proximity of the second mobile device so that the first mobile device can receive a sidelink discovery message announced by the second mobile device.

The following can be the description of each step (or, one or more steps) for this scenario. At Step 1, when the first mobile device is powered on, it performs cell selection and then camps on a serving cell. The first mobile device receives minimum SI from a gNB cell (e.g., BS device 100) of the serving cell.

At Step 2, the first mobile device performs an initial attach to core network (e.g., NR core network, CN, NR Core) and enters RRC_CONNECTED state, and the related registration and authorization/authentication can be completed. The authorization/authentication procedure with the core network may be used for getting authority and information to perform sidelink service.

At Step 3, when the first mobile device is configured by upper layer (e.g. RRC sublayer) to monitor discovery message, the first mobile device needs to know discovery reception pool. The first mobile device can check whether the serving cell supports D2D (sidelink) service e.g., via system information (e.g., the minimum SI and/or other SI for D2D/sidelink service). The first mobile device may send a request to the gNB (e.g., BS device 100) to provide the system information. In the system information, information related to the discovery reception pool can be included.

At Step 4, if the first mobile device is in RRC_CONNECTED, first mobile device can send sidelink information message to indicate to the gNB (e.g., BS device 100) that the first mobile device is interested in reception of discovery message.

At Step 5, the first mobile device monitors discovery messages in the discovery reception pool. At Step 6, if the first mobile device receives interested discovery message and needs further information of received discovery message, the first mobile device will access the core network for obtaining the further information (e.g., restaurant menu, first mobile device identity of discovery message transmitter, . . . ) via e.g., MATCH report procedure in 3GPP TS 23.303 v14.0.0. An entity in the core network for providing the further information can be a ProSe Function 3GPP TS 23.303 v14.0.0.

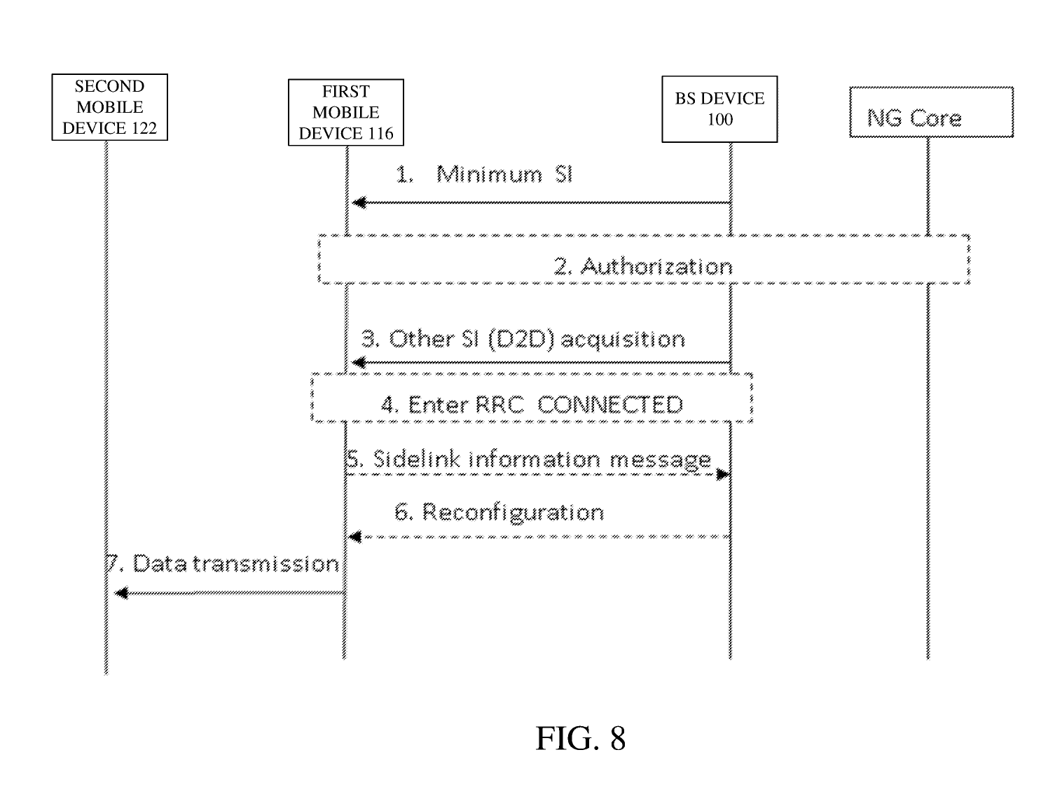

FIG. 8 illustrates an example, non-limiting flow diagram showing the steps for performing sidelink communication transmission to facilitate reporting assistance information for sidelink service in accordance with one or more embodiments described herein.

One or more steps can be performed by sidelink control component 504 in various embodiments. In one scenario, FIG. 8 shows an embodiment of sidelink communication transmission. Both first mobile device and second mobile device are capable of sidelink communication. The first mobile device is within a cell controlled by a gNB (e.g., BS device 100). The second mobile device can be also within the cell or another cell controlled by the gNB (e.g., BS device 100) or another gNB (not shown). The second mobile device can be in the proximity of the first mobile device.

The following can be the description of each step (or one or more steps) for this scenario. Step 1: When the first mobile device is powered on, it performs cell selection and then camps on a serving cell. The first mobile device receives the minimum SI from a gNB (e.g., BS device 100) of the serving cell. At Step 2, first mobile device performs authorization procedure with NG core for getting authority and information to perform sidelink service.

At Step 3, first, first mobile device needs to check whether the serving cell support sidelink service. The first mobile device will acquire system information related to device-to-device (sidelink) service based on certain procedure (e.g., preamble transmission and/or random access like procedure), if the first mobile device is in RRC_IDLE state. Else, if the first mobile device is in RRC_CONNECTED state, the first mobile device will send a system information request RRC message to network for obtaining valid discovery system information.

At Step 4, if first mobile device is released to RRC_IDLE state and no transmission resource pool is provided for first mobile device in RRC_IDLE state, the first mobile device will need to enter RRC_CONNECTED state for requesting transmission resource.

At Step 5, if the first mobile device is in RRC_CONNECTED state, the first mobile device will send a sidelink information message (e.g. sidelinkUEInformation) to network (e.g., gNB (e.g., BS device 100)) for requesting transmission resource and/or informing network other assistance information. At Step 6, network allocates transmitting resource pool either in other SI including sidelink related information or in dedicated RRC message (e.g., reconfiguration). Network may provide one or multiple transmitting resource pool(s). Network allocates receiving pool through other SI.

At Step 7, first mobile device performs data transmission based on resource allocation in previous step, if the first mobile device is in RRC_CONNECTED, or based on transmission resource pool provided in other SI for sidelink service, if the first mobile device is in RRC_IDLE state. The resource allocated in previous step can be scheduled based on mobile device SL BSR or mobile device autonomous selection.

In LTE, the first mobile device in RRC_CONNECTED performs sidelink communication/discovery based on transmission resource and/or reception resource pool allocated by network. For the first mobile device in RRC_CONNECTED state, the first mobile device should transmit sidelinkUEInformation to network for requesting transmission resource. And the first mobile device should use reception pool(s) provided in system information for receiving sidelink communication/discovery regardless the first mobile device in which state e.g., RRC_CONNECTED state or RRC_IDLE state.

According to current NR design, most of system information in LTE except for cell accessing will be considered as other SI. Based on same consideration, the system information for sidelink communication/discovery will also belong to other SI. Moreover, based on current NR design, the first mobile device in RRC_CONNECTED state will have to transmit a request (e.g., dedicated RRC message) for requesting the other SI for sidelink service.

Based on 3GPP TS 36.331 v14.1.0 and the current NR design, if the first mobile device in RRC_CONNECTD wants to start a sidelink service, the first mobile device needs to transmit a first request message (e.g., a specified RRC signaling) for requesting other SI for sidelink service. After the first mobile device obtains valid other SI for sidelink service, the first mobile device will also need to transmit a second request message (as e.g., sidelinkUEInformation of 3GPP TS 36.331 v14.1.0 in LTE) to network for requesting transmission resource.

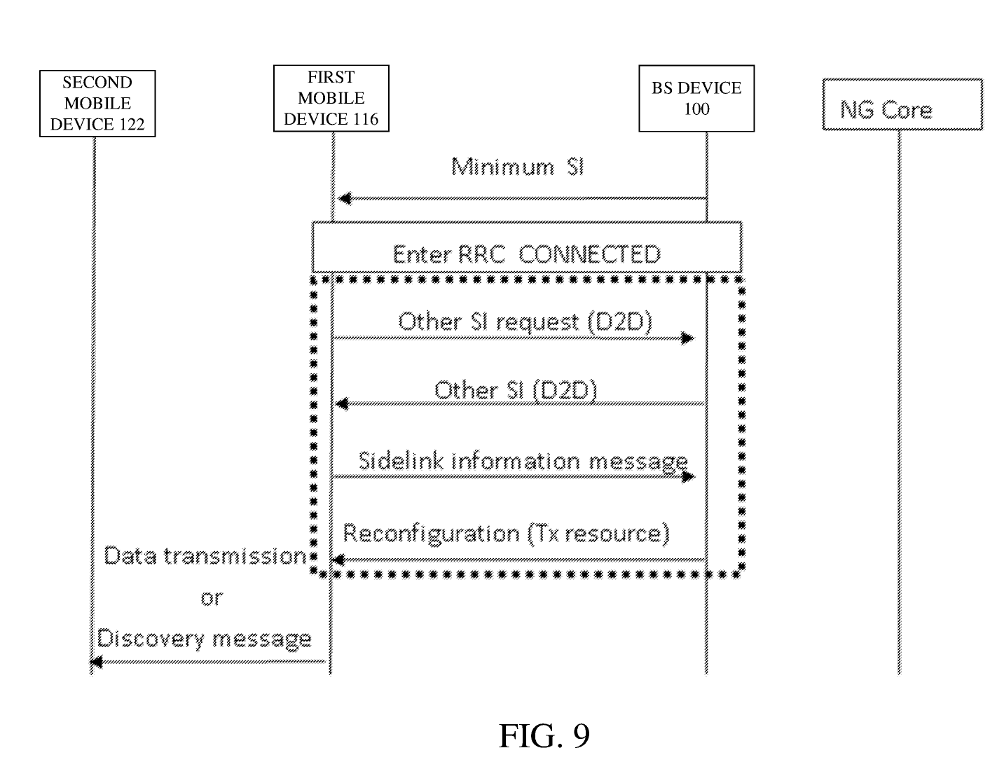

In our view, the procedure of signaling flow (e.g., sending the first request message and the second request message and receiving corresponding information) has redundant steps and will cause extra delay and signaling overhead. FIG. 9 illustrates an example, non-limiting flow diagram showing a procedure to facilitate reporting assistance information for sidelink service in accordance with one or more embodiments described herein. Hence, one or more embodiments described herein provides an enhancement to combine the first request message (e.g., other SI request) and the second request message (e.g., sidelink information message) for preventing (or reducing) redundant signaling.

A specific signaling, which is used to indicate gNB (e.g., BS device 100) about need of both related configuration for sidelink and/or other SI for sidelink service, can be considered. In one alternative, the specific signaling can be a sidelink information message. In one alternative, the specific signaling can be another SI request message. The first mobile device can receive from the gNB (e.g., BS device 100) the related configuration for sidelink and the other SI for sidelink service after transmission of the specific signaling.

For example, the first mobile device could transmit a sidelink information message to the gNB (e.g., BS device 100) to acquire both related configuration and also other SI for sidelink communication and/or discovery. The sidelink information message may include an indication for indicating whether the first mobile device needs another SI or not. More specifically, if the first mobile device already has valid other SI for sidelink service but needs to transmit the sidelink information message for other purpose (e.g., request other sidelink service or request other configuration), the first mobile device has no need to set/include the indication in such case. If the first mobile device set/include the indication in the sidelink information message, the network may provide the other SI for sidelink service to the first mobile device through either dedicated RRC message or broadcasted common RRC message. The contents of other SI for sidelink service provided to a RRC_CONNECTED mobile device may be different from the contents of other SI for sidelink service provided to RRC_INACTIVE mobile devices and/or RRC_IDLE mobile devices. For example, the other SI for sidelink service provided to a RRC_CONNECTED mobile device may not include information of transmission resource pool for which mobile devices in RRC_IDLE state can use for sidelink transmission. Moreover, indication for sidelink discovery and/or indication for sidelink communication and/or indication for different sidelink services (e.g. V2X) may be independent.

As another example, the first mobile device transmits other SI request to the gNB (e.g., BS device 100) to acquire both related configuration and also other SI for sidelink communication and/or discovery. The other SI request may include information element for the related configuration for sidelink communication and/or sidelink discovery. In addition, the other SI request may include information element for the other SI for sidelink communication and/or sidelink discovery. The information element for requesting the related configuration and the other SI of sidelink service can be different, because the change frequency for the other SI and the related configuration can be very different. The information element for requesting sidelink discovery, sidelink communication and/or other sidelink service (e.g., V2X) can be merged or independent. The benefit of this alternative is to reduce specification efforts for more RRC messages.

Moreover, for both alternatives, the first mobile device may trigger to transmit the combined message in any of following conditions: (1) if the first mobile device enters RRC_CONNECTED state from either RRC_IDLE state or RRC_INACTIVE state and the first mobile device is still interested to perform sidelink transmission; (2) if the first mobile device needs to request valid other SI for sidelink service; (3) if the interest of performing sidelink related behavior(s) is changed (compared with last transmission); (4) if the resource request related contents are changed (compared with last transmission); (5) if the contents of the combined message are changed (may exclude indication for other SI request); and/or (6) if the first mobile device enters RRC_CONNECTED state from RRC_IDLE state and the first mobile device is interested in sidelink service (e.g., sidelink reception, sidelink transmission, sidelink scheduling, sidelink synchronization, and/or etc.).

Note: Once first mobile device enters RRC_IDLE state, sidelink information message transmitted before entering RRC_IDLE state cannot be used to compared with new sidelink information message for condition (3), (4), and/or (5) noted above. As such, the sidelink information message cannot be used because the network does not store the content of the sidelink information message in case the network indicates the mobile device to enter RRC_IDLE state. In case the mobile device is indicated to enter RRC_INACTIVE, the network stores the content of the sidelink information message so that the mobile device does not need to send the same content of the sidelink information message.

For both alternatives, the first mobile device may not trigger to transmit the combined message in any of following conditions: (A) the first mobile device enters RRC_CONNECTED from RRC_INACTIVE state and the first mobile device is interested in sidelink, but is not interested in performing sidelink transmission or doesn't need to request system information for sidelink service. Moreover, even if other SI request and sidelink information message are not combined, the first mobile device could still transmit sidelink information message based on some conditions mentioned above. For example, first mobile device could follow conditions (1), (3), (4), (6), and/or (A).

In one embodiment, the first mobile device can transmit the sidelink information message when the first mobile device is in RRC_CONNECTED state and contents for report are changed (e.g., condition (3) and/or condition (4)). The first mobile device could also transmit the sidelink information message when the first mobile device enters RRC_CONNECTED state from RRC_IDLE state and the first mobile device is interested in sidelink. On the other hand, the first mobile device could prevent to transmit the sidelink information message if the first mobile device enters RRC_CONNECTED state from RRC_INACTIVE state and the first mobile device is interested in sidelink reception but not sidelink transmission. The network could store the first mobile device sidelink related information (e.g., in AS-context) when releasing the first mobile device into RRC_INACTIVE state. Based on such information, network could understand the first mobile device interest when the first mobile device resumes the connection. If the first mobile device is released into RRC_IDLE state, then the network may not be able to fetch the first mobile device sidelink related information. As consequence, the first mobile device entering RRC_CONNECTED state from RRC_IDLE state will need to always report information (if the first mobile device is still interested in sidelink).

However, since resource allocation is more sensitive and needs authorization, the interest of sidelink transmission will need to be reported even if the first mobile device enters RRC_CONNECTED state from RRC_INACTIVE state. In addition, if the first mobile device enters RRC_CONNECTED state from RRC_INACTIVE state and is not interested in sidelink service, the first mobile device may still need to transmit the sidelink information message for notifying network.

For both alternatives, the combined message may always report complete information to network instead of partial or delta report. For example, the first mobile device sends the combined message for indicating that it needs other SI for sidelink communication and transmission resource for sidelink communication in last time. And if the first mobile device wish to request discovery related other SI with no change for sidelink communication, then the first mobile device will transmit the combined message for indicating that request of other SI of sidelink discovery and sidelink communication and transmission resource sidelink communication. Based on e.g., last received combined message, first mobile device RRC state condition change and/or etc., the network will decide whether to provide other SI for sidelink communication and new transmission resource for sidelink communication.

For both alternatives, the combined message may be reported in delta or partial way. For example, the first mobile device only sends different part (e.g., new information or indication or changed part) through the combined message.

And the main difference between the two alternatives can be that the other SI request message can be used to request system information which not related to sidelink/D2D service (e.g., MBMS, ETWS, inter-rat mobility, SCPTM), but the sidelink information message cannot.

In one or more embodiments, a computer-implemented method of operation of the mobile device (e.g., first mobile device) can be as follows: the first mobile device enters RRC_CONNECTED state; the first mobile device transmits a message to a network node after enters RRC_CONNECTED state, wherein the message includes a first indication for requesting a system information for a first sidelink service and a second indication for requesting transmission resource for a second sidelink service.

In some embodiments, the first mobile device receives the system information for the first sidelink service and the transmission resource for the second sidelink service. The message can include a third indication for requesting system information not related to sidelink.

In some embodiments, the second indication is amount of discovery messages. In some embodiments, the second indication is a transmission destinations list. In some embodiments, the second indication is an interest indication for indicating whether the first mobile device wants to perform sidelink transmission.

In some embodiments, the first indication is set to a first value when the first mobile device has the system information for the first sidelink service and is set to a second value when the first mobile device needs the system information for the first sidelink service, and the first value and the second value are different. In some embodiments, the first indication is included if the first mobile device needs the system information for a first sidelink service.

Another computer-implemented method for the mobile device can be as follows: the first mobile device transmits a message to a network node after the mobile device enters RRC_CONNECTED state for requesting system information for a first sidelink service and transmission resource for a second sidelink service; and the first mobile device receives the system information for the first sidelink service and the transmission resource for the second sidelink service.

In some embodiments, the first sidelink service is sidelink discovery. In some embodiments, the first sidelink service is sidelink communication. In some embodiments, the first sidelink service is V2X or V2V service. In some embodiments, the first sidelink service is sidelink relay service.

In some embodiments, the second sidelink service is sidelink discovery. In some embodiments, the second sidelink service is sidelink communication. In some embodiments, the second sidelink service is V2X or V2V service.

In some embodiments, the second sidelink service is sidelink relay service. In some embodiments, the first sidelink service is same as the second sidelink service. In some embodiments, the first sidelink service is different from the second sidelink service.

Another computer-implemented method for operation of the mobile device can be as follows: the first mobile device enters a RRC_CONNECTED state; the first mobile device transmits a first message to a network node after the first mobile device enters the RRC_CONNECTED state, wherein the first message includes a first indication for requesting a system information for sidelink and a second indication for requesting transmission resource for a sidelink service. In some embodiments, the first mobile device receives the system information for sidelink and the transmission resource for the sidelink service after transmitting the first message.

In some embodiments, the second indication is a transmission destinations list. In some embodiments, the first mobile device transmits the first message after the first mobile device enters the RRC_CONNECTED state from a RRC_INACTIVE state. In some embodiments, the first mobile device transmits a second message to the network node after the first mobile device enters the RRC_CONNECTED state from a RRC_IDLE state, if the first mobile device is interested in performing sidelink reception for the sidelink service and doesn't request either the system information for sidelink or the transmission resource for the sidelink service.

In some embodiments, the second message doesn't include the first indication and/or the second indication. In some embodiments, the first message and the second message are sidelink information message. In some embodiments, the first mobile device doesn't transmit the first message to the network node after the first mobile device enters the RRC_CONNECTED state from the RRC_INACTIVE state, if the first mobile device is interested in performing sidelink reception for the sidelink service and doesn't request either the system information for sidelink or the transmission resource for the sidelink service. In some embodiments, the network node is a base station.

Another computer-implemented method of operation of the mobile device can be as follows: transmitting a first sidelink information message in a first serving cell by the first mobile device, wherein the first mobile device is in a first RRC_CONNECTED state; entering a RRC_INACTIVE state from the first RRC_CONNECTED state; and transmitting a second sidelink information message in a second serving cell when entering a second RRC_CONNECTED state from the RRC_INACTIVE state, if the first mobile device is interested in sidelink transmission; not transmitting the second sidelink information message in the second serving cell when entering the second RRC_CONNECTED state from the RRC_INACTIVE state, if the first mobile device is not interested in sidelink transmission but is interested in sidelink reception.

In some embodiments, a first interest indication included in the first sidelink information message indicates the first mobile device is interested in sidelink reception. In some embodiments, a second interest indication included in the first sidelink information message indicates the first mobile device is interested in sidelink transmission. In some embodiments, a first interest indication included in the second sidelink information message indicates the first mobile device is interested in sidelink reception.

In some embodiments, a second interest indication included in the second sidelink information message indicates the first mobile device is interested in sidelink transmission. In some embodiments, the second interest indication is a transmission destination list.

In some embodiments, the first interest indication of the second sidelink information message is the same as the first interest indication of the first sidelink information message when the first mobile device transmits the second sidelink information message. In some embodiments, the second interest indication of the second sidelink information message is the same as the second interest indication of the first sidelink information message when the first mobile device transmits the second sidelink information message.

In some embodiments, if the first interest indication of the second sidelink information message is the same as the first interest indication of the first sidelink information message, the first mobile device does not transmit the second sidelink information message. In some embodiments, the first mobile device enters the RRC_CONNECTED state from a RRC_IDLE state and transmits a third sidelink information message in a third serving cell if the first mobile device is interested in sidelink transmission.

In some embodiments, the first mobile device is not interested in sidelink reception. In some embodiments, a second interest indication included in the third sidelink information message indicates the first mobile device is interested in sidelink transmission. In some embodiments, the first mobile device enters a third RRC_CONNECTED state from a RRC_IDLE state and transmits a third sidelink information message in a third serving cell if the first mobile device is not interested in sidelink transmission but is interested in sidelink reception.

In some embodiments, the first interest indication of the second sidelink information message are the same as the first interest indication of the first sidelink information message when the first mobile device does not transmit the second sidelink information message. In some embodiments, the first mobile device enters the RRC_CONNECTED state from a RRC_IDLE state and transmits a third sidelink information message in a third serving cell if the first mobile device is interested in sidelink transmission.

In some embodiments, the first mobile device is not interested in sidelink a second interest indication included in the third sidelink information message indicates the first mobile device is interested in sidelink transmission. In some embodiments, the first mobile device enters the RRC_CONNECTED state from a RRC_IDLE state and transmits a third sidelink information message in a third serving cell if the first mobile device is interested in sidelink reception.

In some embodiments, the first mobile device is not interested in sidelink transmission. In some embodiments, a first interest indication included in the third sidelink information message indicates the first mobile device is interested in sidelink reception. In some embodiments, the first serving cell is the same as the second serving cell. In some embodiments, the third serving cell is the same as the first serving cell.

In another embodiment, a mobile device can comprise: a control circuit; a processor installed in the control circuit; a memory installed in the control circuit and operatively coupled to the processor, wherein the processor is configured to execute a program code stored in the memory to perform the computer-implemented method step(s) as defined in anyone of the preceding computer-implemented methods described.

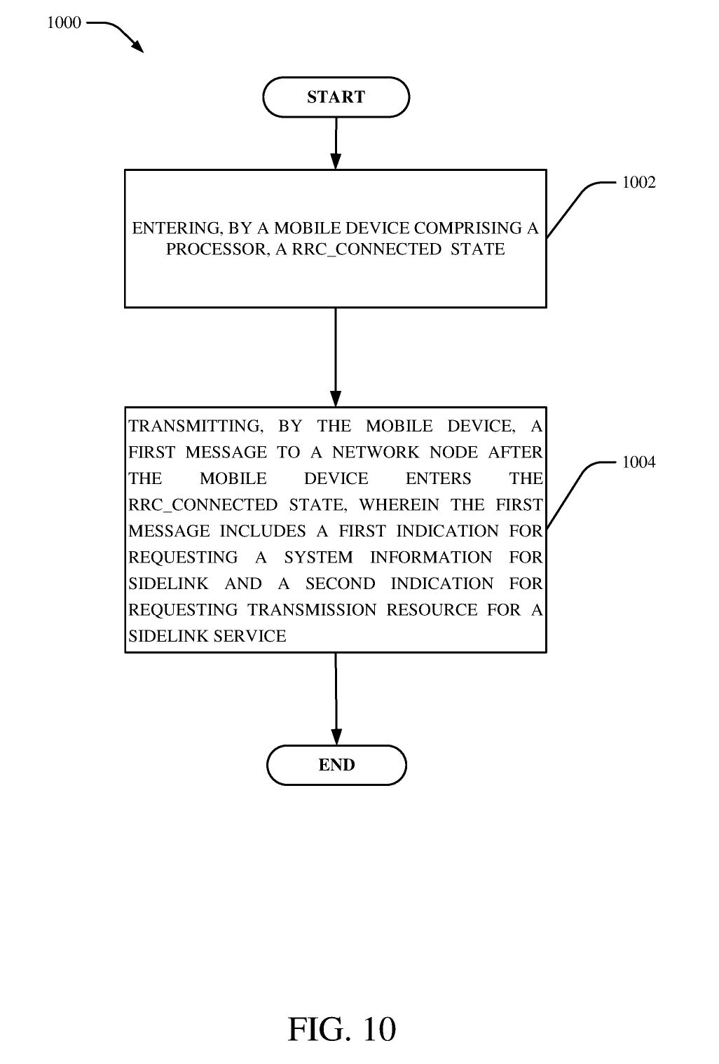

FIGS. 10, 11, 12 and 13 illustrate example, non-limiting flowcharts of computer-implemented methods facilitating reporting assistance information for sidelink service in accordance with one or more embodiments described herein. Turning first to FIG. 10, at 1002, method 1000 can comprise: entering, by a mobile device comprising a processor, a RRC_CONNECTED state. At 1004, method 1000 can comprise transmitting, by the mobile device, a first message to a network node after the mobile device enters the RRC_CONNECTED state, wherein the first message includes a first indication for requesting a system information for sidelink and a second indication for requesting transmission resource for a sidelink service.

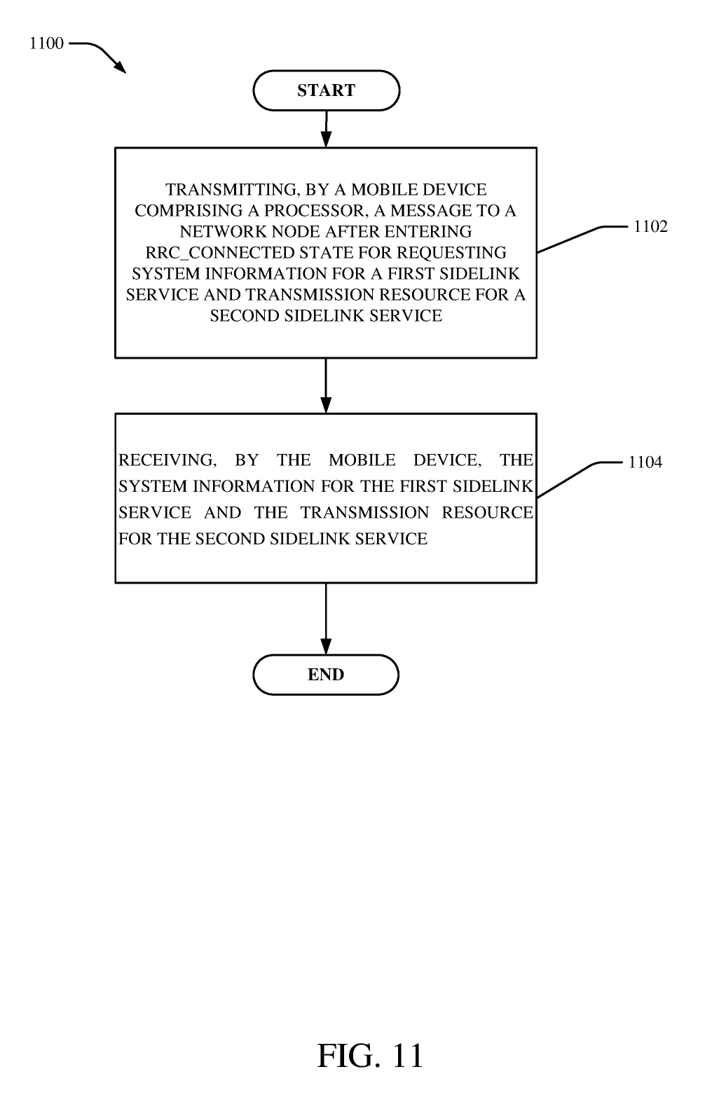

Turning now to FIG. 11, at 1102, method 1100 can comprise: transmitting, by a mobile device comprising a processor, a message to a network node after entering RRC_CONNECTED state for requesting system information for a first sidelink service and transmission resource for a second sidelink service, and at 1104, method 1100 can comprise receiving, by the mobile device, the system information for the first sidelink service and the transmission resource for the second sidelink service.

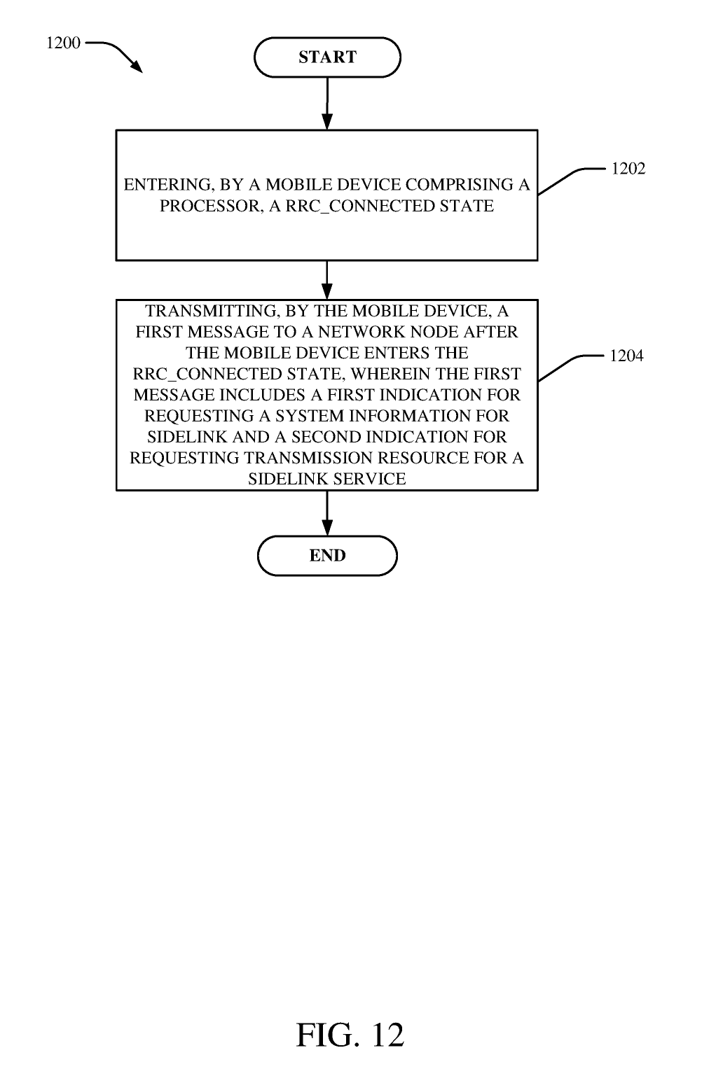

Turning now to FIG. 12, at 1202, method 1200 can comprise: entering, by a mobile device comprising a processor, a RRC_CONNECTED state, and at 1204, method 1200 can comprise transmitting, by the mobile device, a first message to a network node after the mobile device enters the RRC_CONNECTED state, wherein the first message includes a first indication for requesting a system information for sidelink and a second indication for requesting transmission resource for a sidelink service.

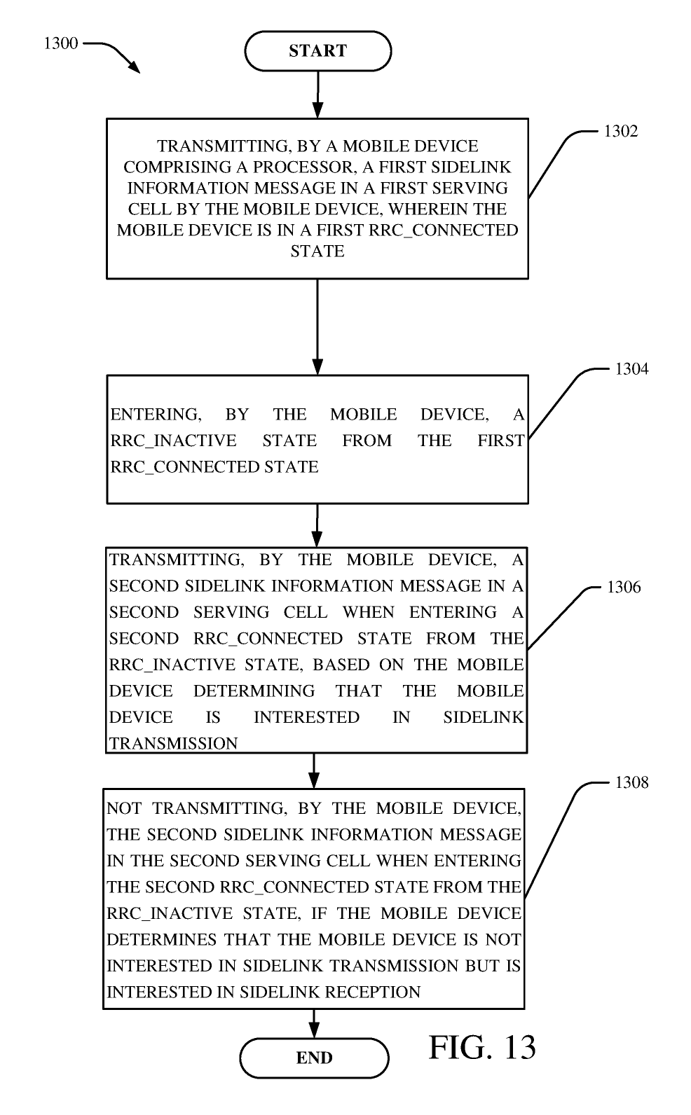

Turning now to FIG. 13, at 1302, method 1300 can comprise: transmitting, by a mobile device comprising a processor, a first sidelink information message in a first serving cell by the mobile device, wherein the mobile device is in a first RRC_CONNECTED state; at 1304, the method comprises entering, by the mobile device, a RRC_INACTIVE state from the first RRC_CONNECTED state. At 1306, the method comprises transmitting, by the mobile device, a second sidelink information message in a second serving cell when entering a second RRC_CONNECTED state from the RRC_INACTIVE state, based on the mobile device determining that the mobile device is interested in sidelink transmission. At 1308, the method comprises not transmitting, by the mobile device, the second sidelink information message in the second serving cell when entering the second RRC_CONNECTED state from the RRC_INACTIVE state, if the mobile device determines that the mobile device is not interested in sidelink transmission but is interested in sidelink reception.

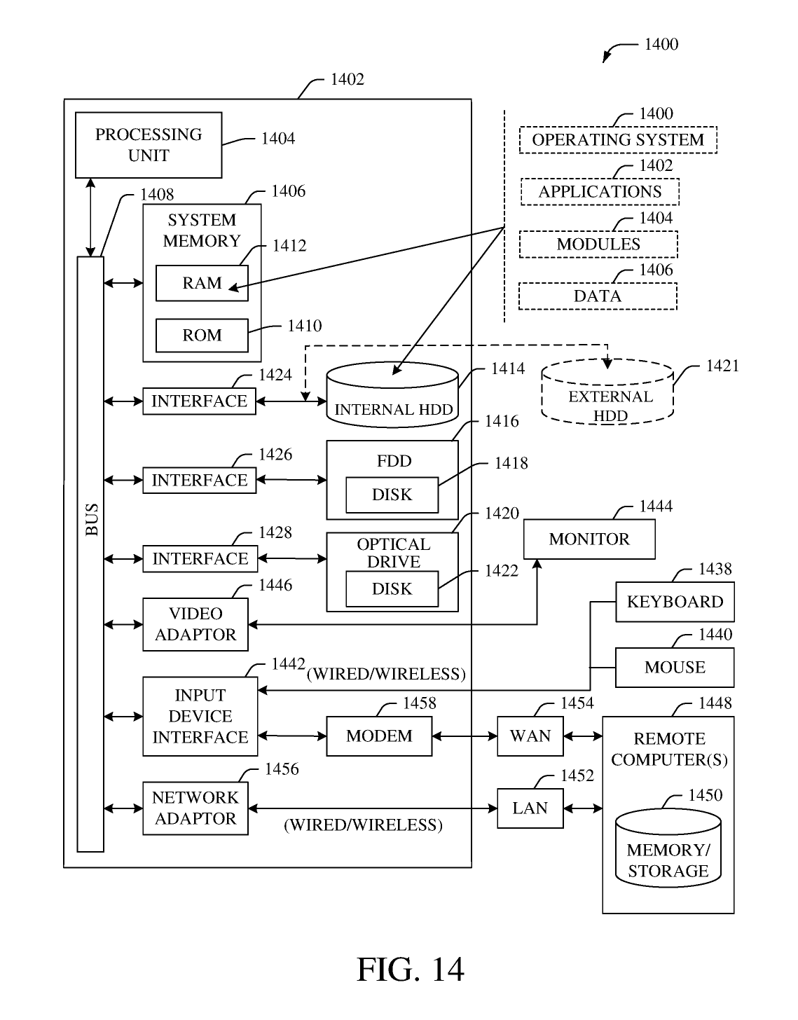

FIG. 14 illustrates a block diagram of a computer that can be employed in accordance with one or more embodiments. Repetitive description of like elements employed in other embodiments described herein is omitted for sake of brevity. In some embodiments, the computer, or a component of the computer, can be or be comprised within any number of components described herein comprising, but not limited to, base station device 100 or mobile devices 116, 122 (or a component of base station device 100 or mobile devices 116, 122).

To provide additional text for various embodiments described herein, FIG. 14 and the following discussion are intended to provide a brief, general description of a suitable computing environment 1400 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules comprise routines, programs, components, data structures, etc., that perform particular tasks or implement particular abstract data types. Moreover, those skilled in the art will appreciate that the inventive methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable (or machine-readable) storage media and/or communications media, which two terms are used herein differently from one another as follows. Computer-readable (or machine-readable) storage media can be any available storage media that can be accessed by the computer (or a machine, device or apparatus) and comprises both volatile and nonvolatile media, removable and non-removable media. By way of example, and not limitation, computer-readable (or machine-readable) storage media can be implemented in connection with any method or technology for storage of information such as computer-readable (or machine-readable) instructions, program modules, structured data or unstructured data. Tangible and/or non-transitory computer-readable (or machine-readable) storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage, other magnetic storage devices and/or other media that can be used to store desired information. Computer-readable (or machine-readable) storage media can be accessed by one or more local or remote computing devices, e.g., via access requests, queries or other data retrieval protocols, for a variety of operations with respect to the information stored by the medium.

In this regard, the term “tangible” herein as applied to storage, memory or computer-readable (or machine-readable) media, is to be understood to exclude only propagating intangible signals per se as a modifier and does not relinquish coverage of all standard storage, memory or computer-readable (or machine-readable) media that are not only propagating intangible signals per se.

In this regard, the term “non-transitory” herein as applied to storage, memory or computer-readable (or machine-readable) media, is to be understood to exclude only propagating transitory signals per se as a modifier and does not relinquish coverage of all standard storage, memory or computer-readable (or machine-readable) media that are not only propagating transitory signals per se.

Communications media typically embody computer-readable (or machine-readable) instructions, data structures, program modules or other structured or unstructured data in a data signal such as a modulated data signal, e.g., a channel wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 14, the example environment 1400 for implementing various embodiments of the embodiments described herein comprises a computer 1402, the computer 1402 comprising a processing unit 1404, a system memory 1406 and a system bus 1408. The system bus 1408 couples system components comprising, but not limited to, the system memory 1406 to the processing unit 1404. The processing unit 1404 can be any of various commercially available processors. Dual microprocessors and other multi-processor architectures can also be employed as the processing unit 1404.

The system bus 1408 can be any of several types of bus structure that can further interconnect to a memory bus (with or without a memory controller), a peripheral bus, and a local bus using any of a variety of commercially available bus architectures. The system memory 1406 comprises ROM 1410 and RAM 1412. A basic input/output system (BIOS) can be stored in a non-volatile memory such as ROM, erasable programmable read only memory (EPROM), EEPROM, which BIOS contains the basic routines that help to transfer information between elements within the computer 1402, such as during startup. The RAM 1412 can also comprise a high-speed RAM such as static RAM for caching data.

The computer 1402 further comprises an internal hard disk drive (HDD) 1410 (e.g., EIDE, SATA), which internal hard disk drive 1414 can also be configured for external use in a suitable chassis (not shown), a magnetic floppy disk drive 1416, (e.g., to read from or write to a removable diskette 1418) and an optical disk drive 1420, (e.g., reading a CD-ROM disk 1422 or, to read from or write to other high capacity optical media such as the DVD). The hard disk drive 1414, magnetic disk drive 1416 and optical disk drive 1420 can be connected to the system bus 1408 by a hard disk drive interface 1424, a magnetic disk drive interface 1426 and an optical drive interface, respectively. The interface 1424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable (or machine-readable) storage media provide nonvolatile storage of data, data structures, computer-executable instructions, and so forth. For the computer 1402, the drives and storage media accommodate the storage of any data in a suitable digital format. Although the description of computer-readable (or machine-readable) storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 1412, comprising an operating system 1430, one or more application programs 1432, other program modules 1434 and program data 1436. All or portions of the operating system, applications, modules, and/or data can also be cached in the RAM 1412. The systems and methods described herein can be implemented utilizing various commercially available operating systems or combinations of operating systems.

A mobile device can enter commands and information into the computer 1402 through one or more wired/wireless input devices, e.g., a keyboard 1438 and a pointing device, such as a mouse 1440. Other input devices (not shown) can comprise a microphone, an infrared (IR) remote control, a joystick, a game pad, a stylus pen, touch screen or the like. These and other input devices are often connected to the processing unit 1404 through an input device interface 1442 that can be coupled to the system bus 1408, but can be connected by other interfaces, such as a parallel port, an IEEE 1394 serial port, a game port, a universal serial bus (USB) port, an IR interface, etc.

A monitor 1444 or other type of display device can be also connected to the system bus 1408 via an interface, such as a video adapter 1446. In addition to the monitor 1444, a computer typically comprises other peripheral output devices (not shown), such as speakers, printers, etc.

The computer 1402 can operate in a networked environment using logical connections via wired and/or wireless communications to one or more remote computers, such as a remote computer(s) 1448. The remote computer(s) 1448 can be a workstation, a server computer, a router, a personal computer, portable computer, microprocessor-based entertainment appliance, a peer device or other common network node, and typically comprises many or all of the elements described relative to the computer 1402, although, for purposes of brevity, only a memory/storage device 1450 is illustrated. The logical connections depicted comprise wired/wireless connectivity to a local area network (LAN) 1452 and/or larger networks, e.g., a wide area network (WAN) 1454. Such LAN and WAN networking environments are commonplace in offices and companies, and facilitate enterprise-wide computer networks, such as intranets, all of which can connect to a global communications network, e.g., the Internet.

When used in a LAN networking environment, the computer 1402 can be connected to the local network 1452 through a wired and/or wireless communication network interface or adapter 1456. The adapter 1456 can facilitate wired or wireless communication to the LAN 1452, which can also comprise a wireless AP disposed thereon for communicating with the wireless adapter 1456.

When used in a WAN networking environment, the computer 1402 can comprise a modem 1458 or can be connected to a communications server on the WAN 1454 or has other means for establishing communications over the WAN 1454, such as by way of the Internet. The modem 1458, which can be internal or external and a wired or wireless device, can be connected to the system bus 1408 via the input device interface 1442. In a networked environment, program modules depicted relative to the computer 1402 or portions thereof, can be stored in the remote memory/storage device 1450. It will be appreciated that the network connections shown are example and other means of establishing a communications link between the computers can be used.

The computer 1402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a defined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a femto cell device. Wi-Fi networks use radio technologies called IEEE 802.11 (a, b, g, n, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands, at an 11 Mbps (802.11a) or 54 Mbps (802.11b) data rate, for example or with products that contain both bands (dual band), so the networks can provide real-world performance similar to the basic 10 Base T wired Ethernet networks used in many offices.

The embodiments described herein can employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of an acquired network. A classifier is a function that maps an input attribute vector, x=(x1, x2, x3, x4, . . . , xn), to a confidence that the input belongs to a class, that is, f(x)=confidence(class). Such classification can employ a probabilistic and/or statistical-based analysis (e.g., factoring into the analysis utilities and costs) to prognose or infer an action that a mobile device desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing mobile device behavior, operator preferences, historical information, receiving extrinsic information). For example, SVMs can be configured via a learning or training phase within a classifier constructor and feature selection module. Thus, the classifier(s) can be used to automatically learn and perform a number of functions, comprising but not limited to determining according to a predetermined criteria which of the acquired cell sites will benefit a maximum number of subscribers and/or which of the acquired cell sites will add minimum value to the existing communication network coverage, etc.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, to optimize space usage or enhance performance of mobile device equipment. A processor can also be implemented as a combination of computing processing units.

As used herein, terms such as “data storage,” “database,” and substantially any other information storage component relevant to operation and functionality of a component, refer to “memory components,” or entities embodied in a “memory” or components comprising the memory. It will be appreciated that the memory components or computer-readable (or machine-readable) storage media, described herein can be either volatile memory or nonvolatile memory or can comprise both volatile and nonvolatile memory.

Memory disclosed herein can comprise volatile memory or nonvolatile memory or can comprise both volatile and nonvolatile memory. By way of illustration, and not limitation, nonvolatile memory can comprise read only memory (ROM), programmable ROM (PROM), electrically programmable ROM (EPROM), electrically erasable PROM (EEPROM) or flash memory. Volatile memory can comprise random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory (e.g., data storages, databases) of the embodiments are intended to comprise, without being limited to, these and any other suitable types of memory.

What has been described above comprises mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “comprises” is used in either the detailed description or the claims, such term is intended to be inclusive in a manner similar to the term “comprising” as “comprising” is interpreted when employed as a transitional word in a claim.

Various aspects of the disclosure have been described above. It should be apparent that the teachings herein can be embodied in a wide variety of forms and that any specific structure, function, or both being disclosed herein is merely representative. Based on the teachings herein one skilled in the art should appreciate that an aspect disclosed herein can be implemented independently of any other aspects and that two or more of these aspects can be combined in various ways. For example, an apparatus can be implemented or a method can be practiced using any number of the aspects set forth herein. In addition, such an apparatus can be implemented or such a method can be practiced using other structure, functionality, or structure and functionality in addition to or other than one or more of the aspects set forth herein. As an example of some of the above concepts, in some aspects concurrent channels can be established based on pulse repetition frequencies. In some aspects concurrent channels can be established based on pulse position or offsets. In some aspects concurrent channels can be established based on time hopping sequences. In some aspects concurrent channels can be established based on pulse repetition frequencies, pulse positions or offsets, and time hopping sequences.

Those of skill in the art would understand that information and signals can be represented using any of a variety of different technologies and techniques. For example, data, instructions, commands, information, signals, bits, symbols, and chips that can be referenced throughout the above description can be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein can be implemented as electronic hardware (e.g., a digital implementation, an analog implementation, or a combination of the two, which can be designed using source coding or some other technique), various forms of program or design code incorporating instructions (which can be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein can be implemented within or performed by an integrated circuit (“IC”), an mobile device, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor can be a microprocessor, but in the alternative, the processor can be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes can be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein can be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium can be coupled to a machine such as, for example, a computer/processor (which can be referred to herein, for convenience, as a “processor”) such the processor can read information (e.g., code) from and write information to the storage medium. A sample storage medium can be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method for a mobile device, comprising:
entering, by the mobile device, a RRC_CONNECTED state; and
transmitting, by the mobile device, a first message to a network node after the mobile device enters the RRC_CONNECTED state, wherein the first message includes a first indication for requesting a system information for sidelink and a second indication for requesting transmission resource for a sidelink service.

2. The method of claim 1, further comprising:
receiving, by the mobile device, the system information for sidelink and the transmission resource for the sidelink service after transmitting the first message.

3. The method of claim 2, wherein the second indication is a transmission destinations list.

4. The method of claim 1, wherein the mobile device transmits the first message after the mobile device enters the RRC_CONNECTED state from a RRC_INACTIVE state.

5. The method of claim 1, further comprising:
transmitting, by the mobile device, a second message to the network node after the mobile device enters the RRC_CONNECTED state from a RRC_IDLE state, based on the mobile device determining that the mobile device is interested in performing sidelink reception for the sidelink service and does not request either the system information for sidelink or the transmission resource for the sidelink service.

6. The method of claim 1, wherein the second message does not include the first indication and/or the second indication.

7. The method of claim 1, wherein the first message and the second message are sidelink information messages.

8. The computer-implemented method of claim 1, further comprising:
not transmitting, by the mobile device, the first message to the network node after the mobile device enters the RRC_CONNECTED state from the RRC_INACTIVE state, based on a determination by the mobile device that the mobile device is interested in performing sidelink reception for the sidelink service and does not request either the system information for sidelink or the transmission resource for the sidelink service.

9. The method of claim 1, wherein the network node is a base station device.

10. A method for a mobile device, comprising:
transmitting, by the mobile device, a first sidelink information message in a first serving cell, wherein the mobile device is in a first RRC_CONNECTED state;
entering, by the mobile device, a RRC_INACTIVE state from the first RRC_CONNECTED state;
transmitting, by the mobile device, a second sidelink information message in a second serving cell when entering a second RRC_CONNECTED state from the RRC_INACTIVE state, based on the mobile device determining that the mobile device is interested in sidelink transmission; and
not transmitting, by the mobile device, the second sidelink information message in the second serving cell when entering the second RRC_CONNECTED state from the RRC_INACTIVE state, if the mobile device determines that the mobile device is not interested in sidelink transmission but is interested in sidelink reception.

11. The method of claim 10, wherein a first interest indication included in the first sidelink information message indicates the mobile device is interested in sidelink reception.

12. The method of claim 10, wherein a second interest indication included in the first sidelink information message indicates the mobile device is interested in sidelink transmission.

13. The method of claim 10, wherein a first interest indication included in the second sidelink information message indicates the mobile device is interested in sidelink reception.

14. The method of claim 10, wherein a second interest indication included in the second sidelink information message indicates the mobile device is interested in sidelink transmission.

15. The method of claim 14, wherein the second interest indication is a transmission destination list.

16. The method of claim 10, wherein the first interest indication of the second sidelink information message is the same as the first interest indication of the first sidelink information message when the mobile device transmits the second sidelink information message.

17. The method of claim 10, wherein the second interest indication of the second sidelink information message are the same as the second interest indication of the first sidelink information message when the mobile device transmits the second sidelink information message.

18. The method of claim 10, further comprising:
entering, by the mobile device, a third RRC_CONNECTED state from a RRC_IDLE state and transmitting a third sidelink information message in a third serving cell if the mobile device is not interested in sidelink transmission but is interested in sidelink reception.

19. The method of claim 10, wherein a first interest indication included in the third sidelink information message indicates the mobile device is interested in sidelink reception.

20. A communication device comprising:
a control circuit;
a processor coupled to the control circuit; and
a memory coupled to the control circuit and operatively coupled to the processor,
wherein the processor is configured to execute a program code stored in the memory to perform method steps comprising:
entering a RRC_CONNECTED state; and
transmitting a first message to a network node after entering the RRC CONNECTED state, wherein the first message includes a first indication for requesting a system information for sidelink and a second indication for requesting transmission resource for a sidelink service.
